(19) United States
(12) Patent Application Publication
(10) Pub. No.: US 2001/0019728 A1
(43) Pub. Date: Sep. 6, 2001

(54) Methods and compositions for protecting plants and crops

(76) Inventors: William H. Basinger, Hiram, GA (US); Alfonso G. Ober, Antofagasta (CL); Hugo R. Naritelli, Santiago (CL)

Correspondence Address: PENNIE AND EDMONDS, 1155 AVENUE OF THE AMERICAS, NEW YORK, NY, 100362711

(21) Appl. No.: 09/729,935

(22) Filed: Dec. 5, 2000

Related U.S. Application Data
(63) Continuation-in-part of application No. 08/919,300, filed on Aug. 28, 1997, now abandoned.

(51) Int. Cl. A01N 59/12

(52) U.S. Cl. 424/667; 504/187

(57) ABSTRACT

Molecular iodine, or a composition or ionic iodine complex which comprises, generates, or chemically or ionically releases molecular iodine, is used alone or mixed with a carrier for use as a plant and crop protectant. Secondary active ingredients, fertilizers, nutrients, phytosterols, micronutrients, promoters, polyaspartates, biomass, surfactants, emulsifiers, oils, odorants, waxes, salts, preservatives, herbicides, fungicides, nematicides, insecticides, bactericides, virucides, fumigants, iodides, rainfastness agents, adhesive extender agents, and tackifying extender agents are optionally added to the carrier for additional plant benefit. The molecular iodine and the desired beneficial additive(s) is applied, directly or indirectly by various methods, to agricultural substances, such as plants and crops, in order to protect the plants and/or crops from pests, such as fungi, nematodes, viruses, bacteria, and weeds which are harmful to plants or crops.

### RELATED U.S. APPLICATION DATA

This application is a continuation in part of application Ser. No. 08/919,300 filed Aug. 28, 1997.

### TECHNICAL FIELD

This invention relates to the use of compositions comprising molecular iodine for protecting plants and/or crops from harmful pests and to methods for use of these compositions.

### BACKGROUND OF THE INVENTION

The protection of plants and crops from pests is of great economic importance to agriculture. In particular, the protection of plants from fungi, nematodes, viruses, bacteria, and weeds is vital to plant life, growth and productivity. An object of the present invention, therefore, is to provide compositions and methods for the use of molecular iodine as a plant and crop protectant.

Iodine in commercial products is frequently complexed with added materials. Iodine complexes comprise elemental iodine and a complexing agent for the iodine. Iodine complexes exist in two forms: (1) ionic and (2) nonionic iodine complexes. Ionic iodine complexes typically comprise elemental iodine and a complexing agent for the iodine, i.e., a type I complexing agent, e.g., a cation, or a type II complexing agent, e.g., an organic group comprising an amine. Nonionic iodine complexes, on the other hand, comprise elemental iodine and a type III complexing agent for the iodine. Polyvinylpyrrolidone-iodine and starch-iodine complexes are examples of nonionic iodine complexes.

There are numerous examples in the literature describing the preparation and/or uses of nonionic iodine complexes in water purification, wound and skin disinfection, equipment disinfection, germicidal solutions and sanitation; e.g., see U.S. Pat. Nos. 2,498,174, 3,244,630, 4,822,592, 4,844,891 and 5,428,050; Japanese patent applications JP 6-172192 A and JP 7-017819 A; and the following technical references: Anon. [Chemical Processing, May (1956), 56-57], A. P. Black et al. [Am. J. Public. Health 49:1060-1068 (1959)], A. P. Black et al. [J. Am. Water Works Assoc. 57:1401-1421 (1965)], and R. Gruening [Specialty Chemicals, August 1996]. For example, C. A. Lawrence et al. [J. Am. Pharm. Assoc., Sci. Ed. 46:500-505 (1957)] disclose that nonionic iodine complexes, i.e., type III iodine complexes such as polyvinylpyrrolidone-iodine, where elemental iodine is solubilized by complexation with one or more nonionic wetting agents, may be used to protect animals against harmful bacteria, fungi and viruses. However, all of these applications involve the protection of animals, particularly humans, and not non-animals such as plants and crops.

There are distinct differences between disinfection applications and plant (or crop) protection applications. First, disinfection targets the control or elimination of pathogens harmful to man or animals. However, many of the compositions useful for disinfection are detrimental to the well-being of plants and/or crops. Therefore, disinfectants and plant (or crop) protectants cannot be used interchangeably. Thus, there is no suggestion that iodine (or a nonionic iodine complex), when applied to a plant and/or crop, will kill pests detrimental to the plant and/or crop without harming the plant and/or crop. Moreover, the level of iodine employed for disinfection and purification purposes as practiced in the prior art is relatively constant whereas the levels of iodine employed in the present invention for plant and/or crop protection may vary considerably to take into account many factors, e.g., soil type, weather conditions, the type of plant and/or crop to be protected, and the individual pest(s) or genus and/or species of pest(s).

In contrast, the present invention using molecular iodine, whether ionically complexed or not, provides methods and compositions for plant and/or crop protection against pests harmful only to plants and/or crops while simultaneously not harming the plant and/or crop.

Employing organic iodides for controlling plant pathogens has been disclosed; e.g., see U.S. Pat. Nos. 3,615,745, 4,977,186 and 5,071,479. For example, U.S. Pat. No. 5,518,692 to Grech et al. discloses that methyl iodide may be applied to stored crops, such as grains, or directly to the soil as a fumigant (in a manner analogous to the use of methyl bromide) out of the planting season when the soil is idle to control or eliminate plant pathogenic organisms such as nematodes, fungi and weeds. The methyl component of the methyl iodide is the active component with the iodine serving only as a convenient leaving group. For example, removal of the iodide anion from methyl iodide in the presence of sulfur results in methylation of the sulfur.

In general, such treatments involve short term exposures to relatively high concentrations of an organic iodide to effect rapid pathogenic organism control or elimination. If the organic iodide is being applied to fumigate the soil, the material is applied while there are no desirable plants and/or crops present to avoid killing them. However, since organic iodides have relatively high volatility and dissipate quickly, they cannot provide long-lasting protection to plants or crops. Moreover, organic iodides, such as methyl iodide, are highly toxic compounds capable of being absorbed into the body by inhalation and by skin contact; therefore, strict precautions to prevent human exposure are mandatory. In contrast, molecular iodine has neither the high volatility nor the high toxicity to humans of organic iodides.

Japanese patent application JP 61-183202 A discloses the spraying of an aqueous solution consisting of 1-3% citric acid and 0.2% iodine over the surface of the leaves and stems of field crops for controlling pest damage and diseases. However, the types of crops protected and the amount of solution to be applied to the crops are not disclosed. Moreover, other than a general reference to bacteria, the types of pests and diseases controlled are not disclosed. This reference teaches that the citric acid is the component which is effective against bacteria and pests. This reference further discloses that the effect of the iodine component is to promote the healthy growth of plants.

U.S. Pat. No. 608,627 to Thiele discloses a mixture of kerosene oil, turpentine oil, 1 teaspoon (4.9 ml) of tincture of iodine, and 10 grains (0.65 grams or 0.020 moles) of sulfur, said to be suitable for killing weevils, which is applied to treat seeds, i.e., corn, bean or pea seeds, by soaking these nongerminated seeds in the mixture for three days before planting the treated seeds. There is no teaching or suggestion in this reference that molecular iodine is even present in the Thiele treatment or that such a treatment would be harmless to any other agricultural substance, e.g., the crops, plants or harvested crops which are the subject of this invention.

U.S. Pat. No. 2,742,736 to MacKay also discloses a very specific treatment— the after-planting treatment of citrus trees already infested with citrus nematode by applying a diluted tincture of iodine solution to the soil surrounding such trees. However, there are no disclosures or suggestions in this reference directed to, for example, any types of crops which could be curatively treated other than citrus, any types of pests which could be curatively treated other than citrus nematode, any curatively application method other than applying a solution to the soil surrounding diseased citrus trees, any pre-planting treatment, and treatments that would preventative pest infestation.

The use of molecular iodine, without a required organic tricarboxylic acid co-additive and optionally with a carrier, for plant and/or crop protection against plant and/or crop pests has not been disclosed previously.

### SUMMARY OF THE INVENTION

One embodiment of the present invention relates to a method for protecting an agricultural substance from pests which are harmful or pathogenic to the agricultural substance, where the method comprises selecting a protectant composition which comprises molecular iodine or which, upon application, releases molecular iodine from molecular iodine, an ionic iodine complex comprising iodine and an ionic complexing agent, and mixtures thereof, and applying the protectant composition to the agricultural substance, which is optionally genetically modified, as many times as necessary per annum in an amount effective to prevent substantial damage to the agricultural substance from the pests thereby protecting the agricultural substance. The agricultural substance may be crops, harvested crops, turf grasses, sod, seedlings, transplants, shrimp, and mixtures thereof. The pest may be fungi, nematodes, viruses, bacteria or weeds. At least one additional additive selected from secondary active ingredients and inert ingredients may be present in the composition, provided that the additive is not a crystalline organic tricarboxylic acid.

This protectant composition may be molecular iodine, an inorganic ionic iodine complex comprising iodine and an inorganic ionic complexing agent, and mixtures thereof and the plant may be at least one of grain-bearing plants, nut-bearing plants, banana plants, pineapple plants, melon plants, strawberry plants, blackberry plants, blueberry plants, peach trees, nectarine trees, pear trees, apple trees, grape vines, vegetable plants, pine trees, olive trees, oil palm trees, rubber trees, coffee plants, cotton plants, ornamental plants, flowers, flowering-bulb-producing plants, tobacco plants, medicinal herbs, and seasoning herbs. The composition may be applied by spraying, overhead irrigation, plant bed irrigation, chemigation, subterranean irrigation, pressure injection, shank injection, incorporation, rototilling and broadcasting. If this composition is directly incorporated into a soil, the composition may be present in the form of a melted liquid, a heated gas, or as solid particles and the application may be made before planting or transplanting. Alternatively, this composition may be applied directly to a soil, before or after planting or transplanting, with an irrigation system comprising a cartridge, optionally in-line, containing a filler comprising the composition. Still alternately, the composition may be applied to a soil or a plant foliage, before or after planting or transplanting, by coating the composition onto a substantially inert solid to form a coated solid, broadcasting the coated solid onto the soil or foliage and, optionally, incorporating the coated solid into the soil.

Another embodiment of the present invention is directed to a method for protecting an agricultural substance from pests which are harmful or pathogenic to the agricultural substance or for curing a pest-damaged agricultural substance, the method comprising selecting a composition which comprises molecular iodine or which, upon application, releases molecular iodine from molecular iodine, an ionic iodine complex comprising iodine and an ionic complexing agent, and mixtures thereof, and applying a sufficient amount of the composition to the agricultural substance, which is optionally genetically modified, directly or indirectly as many times as necessary per annum so as to result in the application of from at least about 2.53 grams to about 80,000 grams of molecular iodine per acre of agricultural substance and so as to prevent substantial damage to the agricultural substance from the pests or to substantially reduce preexisting damage to the agricultural substance caused by the pests. The pest may be fungi, nematodes, viruses, bacteria or weeds. Alternatively, from at least about 5,000 grams to about 25,000 grams of molecular iodine per acre of agricultural substance may be applied. At least one portion of the plants, selected from fruits, vegetables and flowers, may be covered before applying the composition to prevent substantial contact between the covered portion and the molecular iodine or ionic iodine complex.

The plants may be grain-bearing plants, nut-bearing plants, banana plants, pineapple plants, melon plants, strawberry plants, blackberry plants, blueberry plants, peach trees, nectarine trees, pear trees, apple trees, grape vines, vegetable plants, pine trees, olive trees, oil palm trees, rubber trees, coffee plants, cotton plants, ornamental plants, flowers, flowering-bulb-producing plants, tobacco plants, medicinal herbs, and seasoning herbs. Alternatively, the plants may be wheat, pecan, peanut, strawberry, blackberry, blueberry, grape, banana, peach, nectarine, apple, tomato and coffee plants, flowers and pine trees. When plants are the agricultural substance, at least a portion of the plants being surrounded by soil and optionally irrigated, the foliar pest may be fungi, viruses or bacteria, and the composition may be applied in a preventative application to at least one of the foliage of the plants, surrounding soil or irrigation water so as to prevent substantial damage to the plants from the foliar pest. Optionally, at least a portion of the plant is surrounded by soil and optionally irrigated, the soilborne pest may be fungi, bacteria or weeds, and the composition is applied in a preventative application to the foliage of the plants, surrounding soil or irrigation water so as to prevent substantial damage to the plants from the soilborne pest.

If desired, plants, at least a portion of the plants being surrounded by soil and optionally irrigated, are protected from the soilborne pests fungi, nematodes and weeds by applying the composition in a preventative application to the plants, surrounding soil or irrigation water so as to prevent substantial damage to the plants from the soilborne pest. When the agricultural substance is plants, optionally comprising crops, and consisting of annual plants, biennial plants and perennial plants, at least a portion of the plants being surrounded by soil and optionally irrigated, the composition may be applied in a preventative application to the plants, crops, surrounding soil or irrigation water so as to prevent substantial damage to the plants or crops from the pest. The annual plant may be vegetable crops and tobacco, the biennial plant may be lilies, foxglove, beets, turnips, parsnip, carrots, artichoke, parsley, cabbage, radish and onion, and the perennial plant may be trees and bushes.

The agricultural substance may be turf grass as, at least a portion of the grass being surrounded by soil and optionally irrigated, and the composition may be applied in a preventative application to the grass, surrounding soil or irrigation water so as to prevent substantial damage to the grass from the pest.

The agricultural substance may be plants, optionally comprising crops, consisting of grape vines, banana plants, stone fruit trees, pome fruit trees, tomato plants, pepper plants, corn plants, rice plants, strawberry plants, tobacco plants, cut-flower-bearing plants, at least a portion of the plants being surrounded by soil and optionally irrigated and the composition may be applied in a preventative application to the plants, crops, surrounding soil or irrigation water so as to prevent substantial damage to the plants or crops from the pest.

An additional embodiment of the present invention is directed to a method for protecting an agricultural substance from pests which are harmful or pathogenic to the agricultural substance or for curing a pest-damaged agricultural substance, the method comprising selecting a composition which comprises molecular iodine or which, upon application, releases molecular iodine from molecular iodine, an ionic iodine complex comprising iodine and an ionic complexing agent, and mixtures thereof, and applying a sufficient amount of the composition to the agricultural substance, which is optionally genetically modified, directly or indirectly as many times as necessary per annum so as to result in the application of from at least about 1.0 gram to about 50,000 grams of molecular iodine per acre-feet of habitat and so as to prevent substantial damage to the agricultural substance from the pests or to substantially reduce preexisting damage to the agricultural substance caused by the pests, where the agricultural substance is selected from commercially raised tilapia, crawfish, crabs, squid, rotifers and shrimp. Here, the pest may be fungi, viruses or bacteria. If the agricultural substance is shrimp, the composition may be applied to a pond or pool containing the shrimp.

A further embodiment of the present invention is directed to a method for protecting an agricultural substance from pests which are harmful or pathogenic to the agricultural substance, where the method comprises selecting at least one agricultural substance from harvested crops and raw agricultural commodities, selecting a protectant composition which comprises molecular iodine or which, upon application, releases molecular iodine from molecular iodine, an ionic iodine complex comprising iodine and an ionic complexing agent and mixtures thereof, and applying a sufficient amount of the protectant composition to the harvested crops as many times as necessary per annum so as to result in the application of from at least about 0.01 grams to about 5,000 grams of molecular iodine per metric ton of harvested crops and so as to prevent substantial damage to the plants from the pests or to substantially reduce preexisting damage to the agricultural substance caused by the pests. The pest may be fungi, bacteria or weeds. The harvested crop may be wheat, pecans, peanuts, strawberries, blackberries, blueberries, grapes, bananas, peaches, nectarines, apples, tomatoes, coffee beans, flowers or softwood products.

Alternatively, a sufficient amount of the composition may be applied to the harvested crops so as to result in the application of from at least about 0.1 grams to about 500 grams of molecular iodine per metric ton of harvested crops. If desired, a sufficient amount of the composition may be applied to the harvested crops so as to result in the application of from at least about 1 gram to about 50 grams of molecular iodine per metric ton of harvested crops. The composition may be applied in a preventative application to the harvested crop so as to prevent substantial damage to the harvested crop. In this instance, the harvested crop may be seeds or tubers, and the pest may be fungi, nematodes, viruses, bacteria or weeds.

When the harvested crop is seeds, the protectant composition may be applied in the form of a concentrated slurry, a powder or as a coating on a substantially inert solid, to the seeds with an applying means to treat the seeds without introducing sufficient moisture to cause the seeds to germinate. The applying means may be selected from a sprayer, a tank-type sprayer, a squeeze applicator, a drillbox, a planter/seed box, a powder duster, a hand-held duster, a paint brush, a tumbler vessel, a rotating vessel, a shaft agitated vessel and a centrifuged vessel.

An alternate embodiment of the present invention is directed to a method for protecting an agricultural substance selected from plants, crops, harvested crops and mixtures thereof, from pests which are harmful, pathogenic or parasitic to the agricultural substance, where the method comprises selecting a protectant composition which comprises molecular iodine or which, upon application, releases molecular iodine from molecular iodine, an ionic iodine complex comprising iodine and an ionic complexing agent, and mixtures thereof and at least one additive selected from secondary active ingredients and inert ingredients, with the proviso that the additive is not a crystalline organic tricarboxylic acid, and applying the protectant composition to the agricultural substance as many times as necessary per annum in an amount effective to prevent substantial damage to the agricultural substance from the pests or to substantially reduce preexisting damage to the agricultural substance caused by the pests. The pest may be fungi, nematodes, viruses, bacteria or weeds. The secondary active ingredient may be at least one herbicide, fungicide, nematicide, insecticide, bactericide, virucide and fumigant.

The protectant composition may be selected from molecular iodine, an inorganic ionic iodine complex comprising iodine and an inorganic ionic complexing agent, and mixtures thereof and, when the agricultural substance is a plant, the plant may be chosen from grain-bearing plants, nut-bearing plants, banana plants, strawberry plants, blackberry plants, blueberry plants, peach trees, nectarine trees, pear trees, apple trees, grape vines, vegetable plants, pine trees, olive trees, oil palm trees, rubber trees, coffee plants, cotton plants, ornamental plants, flowers, and flowering, bulb producing plants.

At least one inert ingredient may be selected from carriers, fertilizers, fertilizer components, nutrients, micronutrients, promoters, polyaspartates, biomass, surfactants, emulsifiers, oils, odorants, waxes, salts, preservatives, iodides, rainfastness agents, adhesive extender agents, and tackifying extender agents. If desired, the inert ingredient may be methyl paraben, propyl paraben, nitrogen, phosphorus, potassium, calcium, magnesium, sulfur, boron, chlorine, copper, iron, manganese, molybdenum, zinc, urea, nitrates, phytosterols, mineral oil, solvents, chelaters, nonylphenol, alkyl polyglycoside oligomers, alkyl polyglucosides, emulsifiers, anionic surfactants, cationic surfactants, amphoteric surfactants, nonionic surfactants, and mixtures thereof.

The inert ingredient may be a liquid carrier or a solid carrier. The liquid carrier may be selected from water, alcohols, oils used in the formulation of agricultural spray emulsions, solvents used in the formulation of agricultural spray emulsions, and mixtures thereof. If desired, the inert ingredient may be a gaseous carrier and the gaseous carrier may be air, nitrogen, the inert gases and mixtures thereof.

Another alternate embodiment of the present invention is directed to a protectant composition for agricultural substances which comprises molecular iodine or which, upon application, releases molecular iodine where the protectant composition is selected from molecular iodine, an ionic iodine complex comprising iodine and an ionic complexing agent, and mixtures thereof, and a gaseous carrier. The gaseous carrier may be air, nitrogen, the inert gases or mixtures thereof. The protectant composition may further comprise at least one additive selected from the group consisting of secondary active ingredients and inert ingredients, provided that the additive is not a crystalline organic tricarboxylic acid. When the protectant composition further comprises at least one secondary active ingredient, that secondary active ingredient may be selected from herbicides, fungicides, nematicides, insecticides, bactericides, virucides, and fumigants.

The protectant composition additive may further comprise at least one inert ingredient selected from carriers, phytosterols, fertilizers, fertilizer components, nutrients, micronutrients, promoters, polyaspartates, biomass, surfactants, emulsifiers, oils, adhesive extender agents, tackifying extender agents, odorants, waxes, salts, preservatives, iodides, and rainfastness agents. If desired, the inert ingredient may be methyl paraben, propyl paraben, nitrogen, phosphorus, potassium, calcium, magnesium, sulfur, boron, chlorine, copper, iron, manganese, molybdenum, zinc, urea, nitrates, phytosterols, mineral oil, solvents, chelaters, nonylphenol, alkyl polyglycoside oligomers, alkyl polyglucosides, emulsifiers, anionic surfactants, cationic surfactants, amphoteric surfactants, nonionic surfactants, and mixtures thereof.

An additional alternate embodiment of the present invention is directed to a method for protecting an agricultural substance from pests which are harmful to the agricultural substance, where the method comprises selecting a protectant composition which comprises molecular iodine or which, upon application, releases molecular iodine from molecular iodine, an ionic iodine complex comprising iodine and an ionic complexing agent, and mixtures thereof, applying the protectant composition to a soil, allowing the protectant composition to penetrate into the soil, and contacting the agricultural substance with the protectant composition, where the protectant composition is applied to the agricultural substance as many times as necessary per annum in an amount effective to prevent substantial damage to the agricultural substance from the pests or to substantially reduce preexisting damage to the agricultural substance caused by the pests. The composition may be applied to the soil before contacting the agricultural substance with the composition and the composition may be applied with an inorganic acid or acetic acid. The agricultural substance may be selected from the plant roots of a plant, seeds, tubers, bulbs and shrimp. The plant with roots may be chosen from grain-bearing plants, nut-bearing plants, banana plants, strawberry plants, blackberry plants, blueberry plants, peach trees, nectarine trees, pear trees, apple trees, grape vines, vegetable plants, pine trees, olive trees, oil palm trees, rubber trees, coffee plants, cotton plants, ornamental plants, flowers, and flowering, bulb producing plants.

A further alternate embodiment of the present invention is directed to a protectant composition for agricultural substances which comprises molecular iodine or which, upon application, releases molecular iodine, where the protectant composition is selected from molecular iodine, an ionic iodine complex comprising iodine and an ionic complexing agent, and mixtures thereof. The protectant composition may consist essentially of at least one ionic iodine complex comprising iodine and an ionic complexing agent where the ionic complexing agent is independently selected from the group consisting of M⁺I⁻, [R-L]⁺I⁻, and mixtures thereof, where M is a cation, R is or comprises an amine, a sulphide or a sulfoxide, and L is hydrogen or a linear, branched or cyclic alkyl cation comprising from about 1 to about 10 carbon atoms formed by removing an iodine anion from an alkyl iodide. M may be selected from Li⁺, Na⁺, K⁺, NH₄⁺, H⁺, ½ Ca²⁺, ½ Fe²⁺ and mixtures thereof, R may be selected from methyl amine, ethanolamine, ethylenediamine, choline, hexamethylenediamine, aniline, dimethyl amine, diethanolamine, cyclopentyl amine, triethyl amine, triethanolamine, pyridine, poly-4-vinylpyridine, piperidine, piperazine, dimethyl sulphide, dimethyl sulfoxide and mixtures thereof, and L may be hydrogen.

The protectant composition may further comprise a liquid carrier or a solid carrier. The liquid carrier may be selected from water, alcohols, oils used in the formulation of agricultural spray emulsions, non-phytotoxic and biodegradable solvents, and mixtures thereof.

### DETAILED DESCRIPTION OF THE INVENTION

As used herein, the term “molecular iodine” includes both I₂ and any composition or ionic iodine complex which comprises, generates or releases I₂. Preferably, the molecular iodine comprises I₂. Most preferably, the molecular iodine is I₂.

As used herein, the term “iodine complex” is defined as a complex which comprises elemental iodine and a complexing agent for the iodine. Iodine complexes consist of ionic iodine complexes and nonionic iodine complexes.

As used herein, the term “ionic iodine complex” is defined as an ionic complex, i.e., comprising elemental iodine and a type I or a type II complexing agent for the iodine which is capable of releasing molecular iodine, i.e., iodine which is titratable with a sodium thiosulfate solution. A standard method for the titration of iodine with sodium thiosulfate is provided in the text “Reagent Chemicals,” 8th Edition, American Chemical Society (Publisher), 1993, p. 383. Optionally, the ionic iodine complex can be generated in situ or prior to mixing with a carrier.

As used herein, a “type I complexing agent” is represented by M⁺I⁻. A type I complexing agent forms an ionic iodine complex, which is inorganic and which is represented by M⁺I⁻₂ₙ₊₁, as follows:

M⁺I⁻+nI₂→M⁺I⁻₂ₙ₊₁ (1)

where M⁺ is a cation; and n is a number such that n≧1. These ionic iodine complexes are typically prepared by mixing an iodide salt (MI) or hydriodic acid with iodine. Preferably, M is selected from the group which includes Li⁺, Na⁺, K⁺, NH₄⁺, H⁺, ½ Ca²⁺, ½ Fe²⁺ and mixtures thereof.

As used herein, a “type II complexing agent”, represented by [R-L]⁺I⁻, is an organic iodide. The positively-charged portion of the type II complexing agent comprises an amine, a sulphide or a sulfoxide, represented by R, and is substituted by a substituent L. A type II complexing agent forms an ionic iodine complex, which is organic and which is represented by [R-L]⁺I⁻₂ₙ₊₁, as follows:

[R-L]⁺I⁻+nI₂→[R-L]⁺I⁻₂ₙ₊₁ (2)

where L is hydrogen or a linear, branched or cyclic alkyl cation comprising from about 1 to about 10 carbon atoms formed by removing an iodine anion from an alkyl iodide; and n is a number such that n≧1. These ionic iodine complexes are typically prepared by: (1) mixing R with an alkyl iodide (LI) and iodine, (2) mixing R with hydriodic acid and iodine, or (3) mixing R with an acid, iodide salt (MI) and iodine. Preferably, R is or comprises a primary, secondary or tertiary amine, a sulphide or a sulfoxide. Most preferably, R is selected from the group which includes methyl amine, ethanolamine, ethylenediamine, choline, hexamethylenediamine, aniline, dimethyl amine, diethanolamine, cyclopentyl amine, triethyl amine, triethanolamine, pyridine, poly-4-vinylpyridine, piperidine, piperazine, dimethyl sulphide, dimethyl sulfoxide and mixtures thereof. Preferably, L is hydrogen or a linear alkyl cation comprising from about 1 to about 10 carbon atoms formed by removing an iodine anion from an alkyl iodide. Most preferably L is hydrogen.

As used herein, the term “nonionic iodine complex” is defined as an organic complex, i.e., comprising elemental iodine and a type III complexing agent for the iodine. As used herein, a “type III complexing agent”, represented by R′, is an organic material capable of complexing with iodine. A type III complexing agent forms a nonionic iodine complex, which is suitably organic and which is represented by R′·I₂, as follows:

R′+I₂→R′·I₂ (3)

Examples of materials useful as R′ include starch, which forms a starch-iodine nonionic complex, and polyvinylpyrrolidone, which likewise forms a polyvinylpyrrolidone-iodine nonionic complex. These nonionic complexes are typically prepared by mixing R′ with iodine. Nonionic complexes, which do not comprise, generate or release molecular iodine in any significant amount, rather which bind iodine to the nonionic complexing agent and thereby interfere with its beneficial properties, are therefore not included among the molecular iodine protectant compositions of the present invention.

Mechanisms by which compositions or ionic iodine complexes may generate or release molecular iodine include but are not limited to: (1) combining an iodate with a reducing agent, (2) exposing an iodide to a source of photons, e.g., sunlight, (3) combining an iodide and an oxidizer at a pH of 7 or below, (4) further adding a catalyst to (3), and (5) releasing iodine from an ionic iodine complex. Suitable iodates include but are not limited to potassium iodate, calcium iodate, sodium iodate and iodic acid. Reducing agents include but are not limited to formic acid and a combination of hydrogen and a catalyst. Iodides include but are not limited to inorganic iodides, e.g., KI, NaI and HI; alkyliodides, e.g., ethyliodide; and aromatic iodides, e.g., iodobenzene. Oxidizers include but are not limited to iodates, chlorates, nitrates, peroxides and oxygen. Catalysts include but are not limited to molybdenum, platinum, rhodium, ruthenium and copper. Complexing agents include type I complexing agents, type II complexing agents and mixtures thereof. Preferred type I complexing agents include Li⁺, Na⁺, K⁺, NH₄⁺, H⁺, ½ Ca²⁺, ½ Fe²⁺ and mixtures thereof. Preferred type II complexing agents include methyl amine, ethanolamine, ethylenediamine, choline, hexamethylenediamine, aniline, dimethyl amine, diethanolamine, cyclopentyl amine, triethyl amine, triethanolamine, pyridine, poly-4-vinylpyridine, piperidine, piperazine, and mixtures thereof.

Although not wishing to be bound by any particular theory, in the present invention molecular iodine is thought to comprise the primary active ingredient of a protectant material which may be applied to or in the vicinity of plants and/or crops and thereby protect plants and/or crops from harmful pests. If the iodine is present in an ionic complex, it is thought that the iodine is released from the complex, for example, chemically or ionically, resulting in the formation molecular iodine which is thought to be effective in protecting plants and/or crops from harmful pests, as discussed above.

As used herein, the term “pesticide” is as defined in 40 C.F.R. § 152.3(s) (1996), i.e., any substance or mixture of substances intended for preventing, destroying, repelling or mitigating any pest, or intended for use as a plant regulator, defoliant or desiccant with the exception of those substances specifically exempted in 40 C.F.R. § 152.3(s) (1 through 3).

As used herein, the term “active ingredient” is as defined in 40 C.F.R. § 152.3(b) (1996), i.e., any substance that will prevent, destroy, repel or mitigate any pest, or that functions as a plant regulator, defoliant or desiccant. As used herein, active ingredients consist of primary active ingredients and secondary active ingredients. Further, the term “primary active ingredient”, as used herein, refers to molecular iodine. As also used herein, the term “secondary active ingredient” includes all active ingredients other than molecular iodine.

As used herein, the term “pest(s)” for plants and/or crops are the pests substantially as defined in 40 C.F.R. § 152.5 (1996), i.e., vertebrate animals other than man, any invertebrate animal other than insects, any plant growing where not wanted, and any fungus, bacterium, virus or other microorganism with the exception of those specifically exempted in 40 C.F.R. § 152.5(d). Exemplary pests are those which adversely affect agricultural substances and include pathogenic fungi, pathogenic nematodes, pathogenic bacteria, pathogenic viruses, weed plants, and weed seeds. Pests adversely affect agricultural substances, e.g., by causing damage, disease, reductions in yield, or failure to thrive.

Pathogenic fungal genuses/species include but are not limited to: Absidia spp., Achyla spp., Acremonium spp., Acrocalymma spp., Acroconideilla spp., Acrophialophora spp., Aecidium spp., Albugo spp., Alternaria spp., Amillaria spp., Amorphotheca spp., Anthracoidea spp., Aphanomyces spp., Apiospora spp., Apiosporina spp., Aristastoma spp., Armillariella spp., Arthrinium spp., Arthroderma spp., Aschersonia spp., Ascochyta spp., Ascosphaera spp., Aspergillus spp., Asperisporum spp., Asteromella spp., Aureobasidium spp., Balansia spp., Basidiophora spp., Beauveria spp., Bifusella spp., Bipolaris spp., Botryodiplodia spp., Botryosphaeria spp., Botrytis spp., Bremia spp., Brunchorstia spp., Calonectria spp., Calostilbe spp., Calostilbella spp., Candidia spp., Ceratocystis spp., Cercoseptoria spp., Cercospora spp., Cercosporidium spp., Cerotelium spp., Chaetoseptoria spp., Chalara spp., Chellaria spp., Chodroplea spp., Chrysomyxa spp., Cintractia spp., Cladosporum spp., Coccididoldes spp., Clpeoporthe spp., Coccodiella spp., Cochliobolus spp., Coleosporum spp., Colletogloeum spp., Colletotrichum spp., Collybia spp., Colpoma spp., Conidiobolus spp., Coniella spp., Coniothyrum spp., Conostroma spp., Cordana spp., Cordyceps spp., Corticium spp., Corynespora spp., Crinipellis spp., Criptostictis spp., Cronartium spp., Cryphonectria spp., Cryptococcus spp., Cryptodiaporthe spp., Cryptostoma spp., Culicinomyces spp., Cumminsiella spp., Cunninghamella spp., Curvularia spp., Cylindrocarpon spp., Cylindrocladiella spp., Cylindrocladium spp., Cylindosporium spp., Cymadothea spp., Cytosphaera spp., Cytospora spp., Dactuliochaeta spp., Davisomycella spp., Deightoniella spp., Debaromyces spp., Dematopora spp., Dendryphion spp., Deuterophoma spp., Diachora spp., Diachorella spp., Diaporthe spp., Dibotryon spp., Dictyoarthrinium spp., Didymella spp., Didymosphaeria spp., Dilophospora spp., Dimeriella spp., Diplocarpon spp., Diplodia spp., Discosphaerina spp., Discosporium spp., Discula spp., Doassansia spp., Dothiora spp., Dothistroma spp., Drechslera spp., Drepanopeziza spp., Elsinoe spp., Elytroderma spp., Embellisia spp., Emmonsiella spp., Endoconidium spp., Endothia spp., Entomophthora spp., Entomosporium spp., Entyloma spp., Entylomella spp., Ephelis spp., Epichloe spp., Epicocum spp., Epidermophyton spp., Eremothecium spp., Erynia spp., Erysiphe spp., Eupenicillium spp., Eurotium spp., Eutypa spp., Exobasidium spp., Exophiala spp., Exserohilum spp., Filobasidiella spp., Fomitopsis spp., Franzpetrakia spp., Fulva spp., Fusarium spp., Fusicladium spp., Fusicoccum spp., Gaeumannomyces spp., Ganoderma spp., Geniculosporum spp., Gerlachia spp., Gibberella spp., Gibellina spp., Gibellula spp., Gibertella spp., Gloeocercospora spp., Gloeosporidiella spp., Gloeotinia spp., Glomerella spp., Gnomonia spp., Graphium spp., Greeneria spp., Gremmeniella spp., Guignardia spp., Gymonconia spp., Gymnosporangium spp., Hainesia spp., Haplobasidion spp., Helminthosporum spp., Hemileia spp., Hemileia spp., Hendersonia spp., Herpotrichia spp., Heterobasidion spp., Hirsutella spp., Histoplasma spp., Hymenostilbe spp., Hymenula spp., Hypoderma spp., Hypodermella spp., Hypodermina spp., Hypoxylon spp., Inocybe spp., Inonotus spp., Isothea spp., Issatchenkia spp., Isthmiella spp., Kabatina spp., Khuskia spp., Kluyveromyces spp., Kuehneola spp., Lachnella spp., Laetiporus spp., Lecanostricta spp., Lepteutypa spp., Leptodothiorella spp., Leptomitus spp., Leptopthyrella spp., Leptosphaeria spp., Leptosphaerulina spp., Leptostroma spp., Leveillula spp., Lirula spp., Lophodermella spp., Lophodermium spp., Lophomerum spp., Macrophomia spp., Magnaporte spp., Marasmius spp., Marssonina spp., Melampsora spp., Melanotaenium spp., Melasmia spp., Meloderma spp., Melodermella spp., Memnoniella spp., Metarhizium spp., Microcyclus spp., Microdochium spp., Micronectriella spp., Microsphaera spp., Microsporum spp., Moesziomyces spp., Monilia spp., Monodictys spp., Monographella spp., Monosporascus spp., Mortierella spp., Mucor spp., Mycena spp., Mycocentrospora spp., Mycogone spp., Mycosphaerella spp., Mycosrinx spp., Mycovellosiella spp., Myrothecium spp., Naemacyclus spp., Nakataea spp., Nannizza spp., Necator spp., Nectria spp., Nematospora spp., Neosartorya spp., Neotestudia Spp., Neozygites spp., Nigrospora spp., Nimbya spp., Nomuraea spp., Oidiopsis spp., Oidium spp., Olivea spp., Ophiodothella spp., Ovularia spp., Paecilomyces spp., Panaeolus spp., Paracercospora spp., Paraisaria spp., Paraphaeosphaeria spp., Penicillium spp., Pericladium spp., Periconia spp., Peronophythora spp., Peronosclerospora spp., Peronospora spp., Pestalotiopsis spp., Pezizella spp., Phacidiopycnis spp., Phacidium spp., Phaeochora spp., Phaeocytostroma spp., Phaeoisariopsis spp., Phaeoramularia spp., Phaeoseptoria spp., Phakospora spp., Phellinus spp., Phialophora spp., Phloeospora spp., Pholiota spp., Phoma spp., Phomopsis spp., Phragmidium spp., Phyllachora spp., Phyllactinia spp., Phylleutypa spp., Phyllosticta spp., Phyllostictina spp., Phyllostictina spp., Physoderma spp., Physopella spp., Phytophthora spp., Pichia spp., Pithomyces spp., Plasmodiophora spp., Plasmopara spp., Pleiochaeta spp., Pleospora spp., Ploilderma spp., Podosphaera spp., Pollaccia spp., Polyporus spp., Polystigma spp., Polythrincium spp., Poria spp., Potebniamyces spp., Prathigada spp., Pseudocercospora spp., Pseudocercosporella spp., Pseudoepicoccum spp., Pseudogibellula spp., Pseudoperonospora spp., Pseudopeziza spp., Pseudoseptoria spp., Puccinia spp., Pucciniastrum spp., Pycnidiella spp., Pyrenochaeta spp., Pyrenophora spp., Pyricularia spp., Pythium spp., Ramularia spp., Ramulispora spp., Rehmiodothis spp., Rhabdocline spp., Rhizna spp., Rhizoctonia spp., Rhizomucor spp., Rhizopus spp., Rhizosphaera spp., Rhynchosphaeria spp., Rhytisma spp., Rigidoporus spp., Rosellinia spp., Saprolegnia spp., Sarea spp., Sarocladium spp., Scirrhia spp., Sclerospora spp., Sclerotinia spp., Scolecobasidium spp., Scopulariopsis spp., Seiridium spp., Selenophoma spp., Septocta spp., Septoria spp., Setosphaeria spp., Soleela spp., Sonderhenia spp., Sorosporium spp., Sphacelia spp., Sphaceloma spp., Sphacelotheca spp., Sphaeropsis spp., Sphaerostilbe spp., Sphaerotheca spp., Spilocaea spp., Spongospora spp., Stachybotrys spp., Stagonospora spp., Stemphylium spp., Stenella spp., Stenocarpella spp., Stigmatula spp., Stigmina spp., Stigmochora spp., Sydowia spp., Synchytrium spp., Taphrina spp., Terriera spp., Thanetophorus spp., Thecaphora spp., Therrya spp., Thielaviopsis spp., Tilletia spp., Tolypocladium spp., Tolyposporium spp., Torulopsis spp., Trabutia spp., Trachysphaera spp., Tranzschelia spp., Trichocladium spp., Trichometasphaeria spp., Trichophyton spp., Trichoscyphella spp., Tryblidiopsis spp., Tubercularia spp., Tryblidiopsis spp., Ulocladium spp., Uncinula spp., Uredo spp., Urocystis spp., Uromyces spp., Ustilaginoidea spp., Ustilago spp., Ustulina spp., Valsa spp., Venturia spp., Verticillium spp., Vladracula spp., Wojnowicia spp., Xylaria spp., Zeus spp., Zimmermanniella spp., Zoophthora spp., and Zythia spp.

Pathogenic nematode genuses/species include but are not limited to: Anguina spp. (Seed Gall), Aphelenchoides spp. (Folair), Belonolaimus spp. (Sting), Bursaphelenchus spp. (pinewood), Criconemoides spp. (Ring), Ditylenchus spp. (Stem, Bulb, and Potato Rot), Dolichodorus spp. (Awl), Globodera spp. (Potato Cyst), Helicotylenchus spp. (Spiral), Hemicycliophora spp. (Sheath), Heterodera spp. (Cyst), Hoplolaimus spp. (Lance), Longidorus spp. (Needle), Meloidogyne spp. (Root Knot), Paratrichodorus spp. (Stubby Root), Paratylenchus spp. (Pin), Pratylenchus spp. (Lesion), Radopholus spp. (Burrowing), Rotylenchulus spp. (Reniform), Tylenchorhynchus spp. (Stunt), and Xiphinema spp. (Dagger),

Pathogenic bacteria genuses/species include but are not limited to: Aeromonas spp., Aeromonas hydrophilia, Acidovorax spp., Agrobacterium spp., Aplanobacter spp., Burkholderia spp., Clavibacter spp., Corynebacterium spp., Curtobacterium spp., Erwinia spp., Nocardia spp., Pseudomonas spp., Rhodococcus spp., Spiroplasma spp., Streptomyces spp., Vibrio spp., Vibrio alginolyticus, Vibrio harveyi, Vibrio parahaemolyticus, Vibrio vulnificus, Xanthomonas spp., and Xylella spp.,

Pathogenic virus genuses/species include but are not limited to: Alfamovirus spp., Alphacryptovirus spp., Badnavirus spp., Begomovirus spp. (Subgroup III Geminivirus), Betacryptovirus spp., Bromovirus spp., Bymovirus spp., Capillovirus spp., Carlavirus spp., Carmovirus spp., Caulimovirus spp., Closterovirus spp., Cucumovirus spp., Curtovirus spp. (Subgroup II Geminivirus), Cytorhabdovirus spp., Dianthovirus spp., Enamovirus spp., Fabavirus spp., Fijivirus spp., Furovirus spp., Hordeivirus spp., Idaeovirus spp., Ilarvirus spp., Luteovirus spp., Machlomovirus spp., Marafivirus spp., Mastrevirus spp. (Subgroup I Geminivirus), Necrovirus spp., Nepovirus spp., Nucleorhabdovirus spp., Oryzavirus spp., Phytoreovirus spp., Potexvirus spp., Potyvirus spp., Rymovirus spp., Sequivirus spp., Sobemovirus spp., Tenuivirus spp., Tobamovirus spp., Tobravirus spp., Tombusvirus spp., Tospovirus spp., Trichovirus spp., Tymovirus spp., Umbravirus spp., Waikavirus spp., banana bunchy top virus, coconut foliar decay virus, “CsVMV-like viruses”, cucumber vein yellowing virus, garlic virus A,B,C,D, grapevine fleck virus, maize white line mosaic virus, olive latent virus 2, ourmia melon virus, Pelargonium zonate spot virus, “Petunia vein clearing-like viruses”, “RTBV-like viruses”, “SbCMV-like viruses”, subterranean clover stunt virus, tobacco stunt virus, TSV (Taura syndrome virus), WSSV (white spot syndrome virus), YHV (yellow head virus), satellite viruses, and viroids.

Weed plants and weed seeds, which includes broadleaf weeds, grass weeds, and sedges, of the varieties which compete with commercially valuable crops or plants for nutrients and/or sunlight, and/or serve as hosts for other plant pathogens previously described, include but are not limited to: Yellow Nutsedge, Purple Nutsedge, Pigweed, Goosegrass, Clover, Chickweed, Crabgrass, Bluegrass, Beggar Weed, and Purslane. As used herein, the term “weed” includes both weed plants and weed seeds.

Typical plant and/or crop pests which the compositions of the present invention are effective in protecting against and/or curing may include fungi, nematodes, viruses, bacteria, insects, and weeds which are harmful to plants and/or crops. Some non-limiting particular applications for these compositions include their use to protect or cure:

harvested bananas from Verticillium theabromae, Gloeosporium musarum and Fusarium (which cause crown rot),

banana plants from Mycosphaerella musicola and Mycosphaerella fijiensis (which cause the foliar fungal disease black sigatoka),

grape vines from Botritis cinerea, Uncinula necator and Rhizopus,

strawberries, blackberries, blueberries and other berries from Botrytis, Altermaria, Rhizoctonia and Mycosphaerella,

citrus plants from Colletotrichum musae and Phytophthora spp. (which cause fruit grey rot),

pear trees from P. syringae pv. Syringae,

apple trees and peppers from Phytophthora spp. (P. cactorum, P. capsici Leonian),

vegetables, apple trees and wheat from Pythium (P. ultimum, P. sylvaticum, etc.) and Rhizoctonia (various),

vegetables from Aphanomyces,

celery plants from Septoria apticola,

almond, peach and nectarine trees from Monilia, Sciertinia, Botrytis, Rhizopus and Pseudomonas syringae pv. syringae,

nut trees from Phymatotrichum omnivorum and Xanthomonas campestris pv. Jugandis,

pecan trees from Mycosphaerella,

peanut plants from Cercospora spp.,

rice plants from Rhizoctonia spp., Helminthosporium oryzae, Cercospora oryzae, Rhyncosporium oryzae, Sarocladium oryzae and Entyloma oryzae,

barley plants from Helminthosporium Teres,

wheat plants from Erisiphe graminis, Helminthosporium Teres and Gaeumannomyces graminis var. tritici (“Take All”),

flower bulbs and strawberries from Scleronum rolfsii,

flowers and ornamental plants from Botrytis, Altermaria, Rhizoctonia and Scletortinia,

tomatoes, peppers, strawberries and white pine from Fusarium, Fusarium oxysporum f. sp. lycopersici (Fusarium Wilt),

white pine from Cylindro cladium spp.,

radiata pine tree from Dothistroma septospora, and

coffee plants from Hemileia Vastratix and Cercospora coffeicola.

As used herein, the term “plant” is defined as any of various photosynthetic, eukaryotic multicellular organisms of the kingdom Plantae, characteristically producing embryos, containing chloroplasts, having cellulose cell walls, and lacking locomotion. Such plants include annual plants, biennial plants and perennial plants. Annual plants are well known to those in the art and include but are not limited to vegetable crops and tobacco. Biennial plants are also well known to those in the art and include but are not limited to lilies, foxglove, beets, turnips, parsnip, carrots, artichoke, parsley, cabbage, radish and onion. Additionally, perennial plants are well known to those in the art and include but are not limited to pome fruit trees, stone fruit trees, timber, ornamental plants, such as bushes and trees, and turf grass.

Plants which may be protected by the compositions of the present invention include but are not limited to grain-bearing plants, such as rice, barley and wheat plants; nut-bearing plants, such as pecan and almond trees and peanut plants; fruit-bearing plants such as banana, pineapple, melon, strawberry, blackberry and blueberry plants, peach, nectarine, pear and apple trees and grape vines; vegetable plants, such as celery, tomato, corn, potato and pepper plants; trees and, in particular, pine trees, such as the radiata pine and white pine; olive trees; oil palm trees; rubber trees; coffee, cotton and tobacco plants; ornamental plants; flowers; flowering, bulb producing plants; medicinal herbs; and seasoning herbs. Preferably, the plants protected by the compositions of the present invention are wheat, pecan, peanut, strawberry, blackberry, blueberry, grape, banana, peach, nectarine, apple, tomato and coffee plants, flowers and pine trees. Alternatively, the plants preferably protected by the compositions of the present invention include grain-bearing plants, nut-bearing plants, banana plants, pineapple plants, melon plants, strawberry plants, blackberry plants, blueberry plants, peach trees, nectarine trees, pear trees, apple trees, grape vines, vegetable plants, pine trees, olive trees, oil palm trees, rubber trees, coffee plants, cotton plants, ornamental plants, flowers, flowering-bulb-producing plants, tobacco plants, medicinal herbs, and seasoning herbs.

As used herein, the term “crop” includes cultivated plants, agricultural produce, and commercially raised waterborne organisms, such as shrimp. Crops may be cultivated for, e.g., food, medical or industrial use. Crops which may be protected by the compositions of the present invention include but are not limited to vegetables, e.g., tomatoes, peppers, corn, potatoes, celery; grains, e.g., rice, barley, wheat; nuts, e.g., almonds, pecans, peanuts; and fruit. Other examples of crops which may be protected by the compositions of the present invention include but are not limited to cacao, sugar cane, sugar beets, coffee beans, rubber latex, cotton, flower bulbs, and commercially raised tilapia, crawfish, crabs, squid, rotifers and shrimp.

As used herein, the term “fruit” encompasses an edible, usually sweet and fleshy, ovary of a seed-bearing plant or the spore-bearing structure of a plant that does not bear seeds. As such, fruits are a subclass of plant crops or products. Fruits which may be protected by the molecular iodine of the present invention include but are not limited to grapes, bananas, peaches, nectarines, pears, apples, grapefruit, tangerines, lemons, limes, and berries, such as strawberries, blackberries and blueberries.

As used herein, the term “harvested crop” is defined as any crop which has been removed from the plant from which the crop was derived. Picked fruit, stored grain, seeds and tubers are examples of harvested crops. A subgroup of harvested crops is know as a raw agricultural commodity or RAC. A RAC is a harvested crop which is sold, unprocessed, to the consumer, for example, those harvested crops found in the produce section of supermarkets, such as apples, peppers and strawberries. An additional subgroup of harvested crops is know is seeds and tubers, i.e., harvested crops which can be used to produce new plants. Preferably, the harvested crops protected by the compositions of the present invention are wheat, pecans, peanuts, strawberries, blackberries, blueberries, grapes, citrus fruit, bananas, peaches, nectarines, apples, tomatoes, coffee beans, flowers and softwood products, e.g., timber hewn from pine trees.

As used herein, the term “agricultural substance” includes plants and their components, such as roots, stems foliage, flowers, etc., crops, harvested crops, and mixtures thereof. Exemplary agricultural substances include vegetable crops and plants, berry fruit crops and plants, berry fruit bushes, flowers, ornamental bushes, pome fruit trees and crops, such as apples and pears, stone fruit trees and crops, such as peaches and plums, grain crops and plants, bulbs, seeds, tubers, turf grass, fruit plants (e.g., bananas), vine crops and plants, tobacco plants, ornamental trees, commodity crops, plants and trees, medicinal plants, herbs and waterborne crops, such as shrimp.

Optimally, the compositions of the invention comprising molecular iodine are applied at a level readily determined by one of ordinary skill in the art which is sufficient to protect or cure the plants and/or crops, i.e., to prevent or reduce substantial damage caused by harmful pests (not necessarily eliminating the pests, however) without itself causing substantial plant or crop damage. The effective amount of molecular iodine applied for plant and/or crop protection is dependant upon a number of factors well known to one of ordinary skill in the art of pesticide application, e.g., upon the type of plant and/or crop, weather conditions, climate, soil and pest(s).

In the present invention, the effective amount of molecular iodine applied to plants for protection from soilborne pests harmful to such plants ranges from at least about 0.1 grams to about 80,000 grams per acre of plants, preferably from at least about 2.53 grams to about 80,000 grams per acre of plants and, most preferably, from at least about 5,000 grams to about 25,000 grams per acre of plants.

The effective amount of molecular iodine applied to plants for protection from foliar pests harmful to such plants ranges from at least about 0.1 grams to about 1000 grams per acre of plants, preferably from at least about 0.1 gram to about 100 grams per acre of plants and, most preferably, from at least about 1 gram to about 100 grams per acre of plants. Citrus plants, e.g., orange, lemon, lime and grapefruit, are particularly amenable to foliar application of the protective compositions of the invention.

The effective amount of molecular iodine applied to harvested crops, for protection of such crops from pests harmful to crops, ranges from at least about 0.01 grams to about 5,000 grams per metric ton of harvested crop, preferably from at least about 0.1 grams to about 500 grams per metric ton of harvested crop and, most preferably, from at least about 1 gram to about 50 grams per metric ton of harvested crop.

Molecular iodine may either be used alone, e.g. in gaseous form for treating harvested grapes, or may be combined with at least one optional additive before being applied onto plants and/or crops for their protection. The additive may be present, e.g., in the form of an secondary active ingredient. Secondary active ingredients may be, for example, herbicides, fungicides, nematicides, insecticides, bactericides, virucides, and fumigants. Preferred secondary active ingredients include but are not limited to the herbicides BACARA® and RAFT® (available from Rhone Poulenc), BRONCO®, ACCORD® and AVADEX® (available from Monsanto); the fungicides FONGRAL®, ARBITRE® and SOLITZ® (available from Rhone Poulenc); the insecticide FIPRONIL (available from Rhone Poulenc); and the fumigants chloropicrin, methyl iodide, metham sodium (e.g., VAPAM®), BASAMID®, TELONE®, and FOSTHIAZATE®.

In a further embodiment, the optional additive may be an inert ingredient. As used herein, the term “inert ingredient” is as defined in 40 C.F.R. § 152.3(m) (1996), i.e., any substance other than an active ingredient which is intentionally included in a pesticide product.

Preferably, the inert ingredient comprises a carrier. In this embodiment, the molecular iodine is added to the carrier before application onto plants and/or crops. This serves three purposes. First, the addition of the molecular iodine to the carrier allows for a small amount of molecular iodine to be distributed over a large surface area. Second, other inert ingredients, which are beneficial to plant and crop protection or growth, can be added to the carrier and distributed along with the molecular iodine. Third, to facilitate application, the protectant composition can be prepared as a concentrate of molecular iodine, and any optional inert ingredient(s) desired, in a carrier and then further diluted before application. The carrier is usually present at the highest percentage level of any of the ingredients present.

The carrier may be present in the form of a solid, a liquid or a gas. The solid carrier is suitably a substantially inert ingredient present in the form of a solid. Liquid and gaseous carriers are preferred. Preferred gaseous carriers include but are not limited to air, nitrogen, the inert gases (i.e., helium, neon, argon, krypton, xenon and radon) and mixtures thereof. When a liquid carrier is selected, it may be aqueous, organic, inorganic, non-ionic, cationic, anionic, or a mixture, emulsion, or suspension or any combination thereof. Preferred liquid carriers include but are not limited to water, alcohols, oils used in the formulation of agricultural spray emulsions suitable for use on plants and/or crops, solvents used in the formulation of agricultural spray emulsions suitable for use on plants and/or crops, particularly the non-phytotoxic and biodegradable solvents, and mixtures thereof. Some examples of liquid carriers include nonylphenol; alpha-alkyl-omega-hydroxypoly(oxoethylene), wherein the alkyl group comprises from 12 to 15 carbon atoms; and the crop oils ORCHEX 796® and ORCHEX 692® made by Esso, an EXXON Company.

Inert ingredient(s) other than the carrier may also be present along with the molecular iodine and other optional additive(s). These inert ingredients include but are not limited to fertilizers, fertilizer components, nutrients, micronutrients, promoters (i.e., of molecular iodine activity, such as methyl paraben and propyl paraben), polyaspartates, biomass, surfactants, emulsifiers, oils, odorants, waxes, salts, preservatives, iodides, rainfastness agents, and extenders, such as adhesive extender agents or tackifying extender agents.

Surfactants are suitably used to improve the coverage of a composition of the invention when that composition is applied to an agricultural substance, particularly foliage. Exemplary surfactants include alkyl polyglucosides and alkyl polyglycoside oligomers, e.g., GLUCOPON® (both available from Henkel), fluorinated carboxylic acids, e.g., FORAFAC® (Atochem), alkyl benzene sulfonates, e.g., CALFOAM® (Pilot Chemical), and all the following materials available from BASF: alkyl ether sulfates, e.g., AVANEL®, phosphate esters, e.g., KLEARFAC®, amine oxides, e.g., MAZOX®, and ethylene oxide/propylene oxide block copolymers, e.g., PLURONIC®.

Emulsifiers are suitably used to improve mixing of the components of a composition of the invention. Exemplary emulsifiers include nonyl phenol (available from Stepan), aromatic alkoxylates, e.g., T-DET® from Harcross and MACOL® from BASF, and all the following materials also available from BASF: amine alkoxylates, e.g., ICOMEN®, alcohol alkoxylates, e.g., ICONOL® and LUTENSOL®, phosphate esters, e.g., MAPHOS®, polyols, e.g., QUADROL®, polycarboxylates, e.g., POLYTERGENT®, and cocoamidopropyl betaines, e.g., MAFOCAB®.

Rainfastness agents are suitably used to prevent a composition of the invention from being washed off the agricultural substance to which the composition is applied. Exemplary rainfastness agents include polymenthenes, such as NU-FILM® from Miller Chemical, and silicone-polyethers, such as SILWET® from OSI.

Extenders are suitably used to improve the tack or adhesion of a composition of the invention to the agricultural substance, particularly foliage, to which the composition is applied. Exemplary extenders include polyvinylpyrrolidone-co-vinylacetate, such as LUVISKOL-VA®, polyvinylpyrrolidone, such as LUVISKOL-K®, polyvinylpyrrolidone-co-vinylimidazole, such as LUVITEK-VP®, all available from BASF.

It is desirable that the inert ingredient not comprise an organic polycarboxylic acid and, particularly, a crystalline organic tricarboxylic acid. As used herein, the term “organic polycarboxylic acid” is defined as an aliphatic hydrocarbon compound uninterrupted by heteroatoms, unsubstituted by heteroatoms and unsubstituted by functional groups other than by a plurality of carboxylic groups, i.e., —COOH. Organic polycarboxylic acids include dicarboxylic acids, e.g., maleic acid and prostanoic acid, and crystalline tricarboxylic acids such as citric acid, but not other derivatives, such as anhydrides and esters, and are further described in the Kirk-Othmer Encyclopedia of Chemical Technology, 3rd Edition, 4:814-869 (1978). However and particularly when applying a composition of the invention to soil, it may be desirable for the optional additive to be an inorganic acid or acetic acid, which may be added to or mixed with the composition before or during application.

While not wishing to be bound by any particular theory, the combination of molecular iodine with a nutrient and/or a micronutrient is thought to enhance the protective effect of the molecular iodine. Preferred inert ingredients, other than carriers, include but are not limited to promoters; plant nutrients, such as nitrogen, phosphorus, potassium, calcium, magnesium, sulfur, boron, chlorine, copper, iron, manganese, molybdenum, zinc, urea and nitrates; phytosterols; mineral oil; solvents; chelaters; emulsifiers, which are optionally ethoxylated; surfactants, e.g., anionic surfactants, cationic surfactants, amphoteric surfactants and nonionic surfactants; and mixtures thereof.

Molecular iodine, in the form of any of the embodiments described above, may be applied to crops, plants, their foliage, their roots, their surrounding soil, in their irrigation water, etc., in the pre-harvest or the post-harvest stage, preventatively or curatively, to obtain the desired level of protection from pests. For example, application may be accomplished by spraying the plants from the ground or from the air. With regard to plant roots, which are usually not exposed to receive atmospheric sprays, application man be made directly or indirectly, e.g., by spraying the surrounding soil with the protectant composition, thus allowing it to penetrate through the soil to reach the roots.

As used herein, the term “soil” includes natural soils, such as earth, dirt, clay, loam and sand, and soil substitutes, such as vermiculite, pearlite, synthetic planting media and peat moss; such soils and soil substitutes are well known to those in the art. Soil application methods are well known to those in the art and include but are not limited to broadcasting, bed irrigation, drip irrigation, which is also known as chemigation because a treatment is applied with the irrigation water, spraying, incorporation, e.g., by rototilling, spraying followed by incorporation, subterranean irrigation, subterranean chemigation, shanking-in, also known as shank injection, and pressure injection such as high pressure injection.

A preventative pre-planting soil application is defined as a protective application(s) made to the soil before planting or transplanting to protect plants or crops from damage at planting and thereafter. A preventative after-planting soil application is defined as a protective application(s) made to the soil as a protective and/or maintenance application after planting or transplanting to protect plants or crops from damage by preventing the pest(s) from attacking the plant or crop. A curative soil application is defined as an application(s) made to the soil after planting to an already diseased agricultural substance in order to cure a preexisting disease of that agricultural substance.

It is preferable to make preventative pre-planting and/or after-planting applications of the compositions of the invention before the onset of disease. This is because it is extremely difficult, if not impossible, to completely cure a pest-infested agricultural substance of that infestation. For example, pest-infested plants are invariably weakened by the pest infestation, which often leads to an eventual recurrence of the original infestation or reduces their resistance to further infestations with other pests. Moreover, the growth rate and/or fruit or crop bearing efficiency of a plant which, at one time, was pest-infested is usually lower when compared with plants that have never been infested.

Therefore and in particular, it is not preferred to apply the compositions of the invention to the soil surrounding diseased citrus trees to cure that disease, especially when that disease is citrus nematode.

Foliar methods of application are well known to those in the art and include but are not limited to boom spray, cannon spray, aerial spray, overhead irrigation, and backpack sprayer application. A preventative foliar application is defined as an application(s) made to plant or crop foliage, optionally on a regular scheduled basis, prior to disease or pest emergence to prevent the presentation of disease. A curative foliar application is defined as an application(s) made to a plant or crop after the presentation of disease in order to cure the plant or crop of the disease. Preventative foliar application(s) of the compositions of the invention are preferred for protecting agricultural substances.

Application methods for harvested crops and raw agricultural commodities are well known to those in the art and include but are not limited to application by sprayer, tank-type sprayer, squeeze applicator, drillbox, planter/seed box, powder duster, hand-held duster or paint brush, application of a coating, and application using a vessel, such as a tumbler vessel, rotating vessel, shaft agitated vessel or centrifuged vessel. Application methods to seeds or tubers are also well known to those in the art and may include all of the above methods plus application by slurry, in which the slurry is preferably concentrated. In either case, the composition applied may be present in any one or more of several forms, for example, as a solid, powder, coating on a substantially inert solid, liquid, solution, suspension, emulsion, slurry, aerosol or gas and, for commercial and economic reasons, it is preferred that the entire treatment process take less than 24 hours per treatment.

Furthermore, applications to plants and/or to crops may be made as many times as necessary per annum to maintain the desired level of protection from pests. The effective amount of molecular iodine applied for each application may vary, as is well known to one of ordinary skill in the art of pesticide application.

The plant and/or crop protectant compositions of the present invention may be applied by any convenient method, for example, by using a fixed application system such as a center pivot irrigation system. Preferably, application to fields of plants and/or crops is made by air spraying, i.e., from an airplane or helicopter, or by land spraying. For example, land spraying may be carried out by using a high flotation applicator equipped with a boom, by a back-pack sprayer or by nurse trucks or tanks. Optionally, application may be made to plants which have their fruit(s), vegetable(s) and/or flower(s) substantially protected from the composition being applied, e.g., by paper or plastic bags.

The following examples are provided to illustrate the preparation of plant and/or crop protectant compositions comprising molecular iodine as the primary active ingredient. The following examples are for the sole purpose of illustration and should not be construed as limiting the scope of the present invention in any sense.

### EXAMPLES

The individual components in the following examples are as parts by weight unless otherwise indicated. In some examples, the least standard deviation (LSD) at the 95% confidence level (p=0.05) is cited. This quantity is well known to those in the art as a common statistical measurement of a significant difference between two quantities and is also sometimes known as Tukey's HSD (p=0.05) (“honestly significantly different”).

The plant and crop protectant compositions of Examples 1 and 2 are in concentrated form and require the proper dilution as would be readily determinable by one of ordinary skill in this art before application to plants and/or crops. Exemplary dilution schedules are provided in Examples 3-6. A specific dilution schedule is given for the plant and crop protectant composition of Example 7. However, one of ordinary skill in this art could readily modify these schedules or determine other suitable dilution schedules, e.g., for different plants, crops and/or pests.

### Example 1

### Plant and Crop Protectant Composition 1

2.5 parts I₂, 1.25 parts KI, 10 parts 85% by weight phosphoric acid, 1 part methyl paraben and 1 part propyl paraben are added to a carrier of 32.5 parts alpha-alkyl-omega-hydroxypoly(oxoethylene), wherein the alkyl group comprises from 12 to 15 carbon atoms, and 54.25 parts water to make 100 parts total of Plant and Crop Protectant Composition 1.

### Example 2

### Plant and Crop Protectant Composition 2

25 parts I₂, 12.5 parts KI, 10 parts methyl paraben, 10 parts propyl paraben, 10 parts magnesium sulfate, 112 parts 85% by weight phosphoric acid, 100 parts potassium nitrate, 87.5 parts urea, 2 parts of the polyvinylpyrrolidone-co-vinylacetate adhesive and/or tackifying extender agent LUVISKOL-VA®, and 25 parts ethylenediamine tetraacetic acid chelated plant microelements (CHAMPION FOLIAR QUELATOS® available from SQM Nitratos) are added to a carrier of 300 parts nonylphenol and 472 parts water to make 1,166 parts total of Plant and Crop Protectant Composition 2. As discussed above, the extender was used to improve the tack or adhesion of this composition to the agricultural substance treated.

The following examples are illustrations of methods for dilution and application of molecular iodine-containing plant and crop protection compositions formed in accordance with the present invention.

### Example 3

### Application of Plant and Crop Protectant Composition 1 to Grape Vines (pre-harvest)

Plant and Crop Protectant Composition 1 solution was diluted as follows prior to application: 0.5 parts composition 1, 5 parts oil (ORCHEX®)) and 30 parts water. The diluted protectant mixture was applied at a rate of 14 liter per acre to grape vines, to all portions of the plants exposed to the atmosphere, in a pre-harvest stage to protect the plants from the fungus Botritis cinerea. This fungus was not present when application of the composition was begun. The effective molecular iodine coverage was 5.1 grams per acre of grape plants. Selected sections of grape vines were sprayed with a similar solution which differed only in that it contained no I₂; these sections were designated as the control group. The solutions were applied at the above rate a total of five times from the time of beginning of flowering to thirty days before harvest. The grape vines sprayed with the composition 1 protectant solution containing molecular iodine showed no sign of disease, in particular Botritis cinerea, unlike the control group which was highly diseased.

### Example 4

### Application of Plant and Crop Protectant Composition 1 to Orange Plants (pre-harvest)

Plant and Crop Protectant Composition 1 solution was diluted as follows prior to application: 0.2 parts composition 1 and 1000 parts water. The diluted protectant mixture was applied by boom spraying at a rate of 900 liters per acre to orange trees, primarily to the leaves, fruit and stems, in the pre-harvest stage (at or near the beginning of fruiting) to protect the plants from the fungi Colletotrichum musae and Phytophthora spp. which cause grey rot. These fungi were not present when application of the composition was begun. The effective molecular iodine coverage was 4.5 grams per acre of orange plants. The protectant mixture was applied at the above rate four times during the pre-harvest period. Water, without composition 1, was applied in the same manner to a control group. The orange plants that were sprayed with the composition 1 protectant solution showed no signs of grey rot, however the orange plants in the control group were severely overtaken with grey rot.

### Example 5

### Application of Plant and Crop Protectant Composition 2 to Banana Plants (pre-harvest)

Plant and Crop Protectant Composition 2 solution was diluted as follows prior to application: 0.25 parts composition 2, 0.12 parts emulsifier (the nonionic emulsifier TRITON X-45® available from Rohm & Haas), 12 parts oil (ORCHEX®) and 3 parts water. The diluted protectant mixture was applied at a rate of 6.0 liters per acre to the leaves and stems of banana plants in a pre-harvest stage to protect the plants from the foliar fungal disease black sigatoka, which is caused by Mycosphaerella musicola and Mycosphaerella fijiensis. These fungi were not present when application of the composition was begun. These fungi are particularly virulent and have developed resistance to most systemic fungicides. Thus, it is highly desirable to have an effective protective composition which can prevent black sigatoka and less desirable to apply a protective composition to already infected banana plants.

During the application, any developing banana clusters were covered with bags before application of the diluted protectant 2. The effective molecular iodine coverage was 2.53 grams per acre of banana plants. Selected sections of banana plants were sprayed with a similar solution, the control composition, which differed only in that it contained no I₂; these sections were designated as the control group. The protectant and control compositions were applied at the above rate to the banana plants, before and after flowering, every 15 days during the rainy season and every 21 days during the dry season. The banana plants sprayed with the solution of protectant 2, containing molecular iodine, showed no sign of infection by the foliar fungal disease black sigatoka. However, the banana plants in the control group were severely infested with black sigatoka.

### Example 6

### Application of Plant and Crop Protectant Composition 1 to Harvested Bananas (post-harvest)

Plant and Crop Protectant Composition 1 solution was diluted as follows prior to application: 0.1 parts composition 1 and 20 parts water. The mixture was applied once, at the rate of 22 liters per metric ton, to harvested bananas for protection against crown rot caused by the fungi Verticillium theabromae, Gloeosporium musarum and Fusarium. These fungi were not present when application of the composition was begun. The effective amount of molecular iodine applied was 2.8 grams per metric ton of bananas. Control groups were sprayed with a similar solution which differed only in that it contained no I₂. After an average of two weeks, the control groups of bananas displayed signs of crown rot however the bananas sprayed with the protectant solution 1, containing molecular iodine, were free of crown rot.

### Example 7

### Plant and Crop Protectant Composition 3

Plant and Crop Protectant Composition 3 was prepared by mixing an active solution and an emulsifier composition. 200 parts by weight I₂ was dissolved in 230 parts by weight of an aqueous potassium iodide solution (57% KI by weight) to make a total of 430 parts of active solution. Separately, an emulsifier composition was prepared by adding 240 parts by weight phosphoric acid (85% by weight), 420 parts by weight of the alkyl polyglycoside oligomer surfactant GLUCOPON®, and 420 parts by weight of the aromatic alkoxylate emulsifier T-DET® to 790 parts by weight water to make 1870 parts of the emulsifier composition. Prior to its application by chemigation, Plant and Crop Protectant Composition 3 was formed by tank mixing 14.4 parts by weight of the emulsifier composition with 1 part by weight of the active solution.

### Example 8

### Iodine (Active) as a Soil Nematicide for Protecting Grape Crops

A composition comprising iodine was tested as a soil nematicide for protecting future grape crops by applying it in the post-harvest cycle at three separate commercial field sites relative to a standard industry treatment and an untreated control. This composition, Plant and Crop Protectant Composition 3, was applied through an existing drip irrigation system, i.e., chemigation was used.

Plant and Crop Protectant Composition 3 was injected into the irrigation system and applied to the soil with 38 mm of irrigation water at the treatment levels specified below. Prior to its injection, the active solution and emulsifier composition components were mixed to form Plant and Crop Protectant Composition 3. The compound FENAMIPHOS®, used in the industry as the standard soil nematicide for grape vines, was used for the treated control. All treatments were compared to untreated soil tested at the same evaluation date to establish the relative efficacies of the other treatments. Thus, there were five separate treatments at each site and each treatment was replicated five times. The following treatment levels were used, each per hectare:

Treatment 1 (T1): 22.6 kg iodine

Treatment 2 (T2): 30.5 kg iodine

Treatment 3 (T3): 45.3 kg iodine

Treatment 4 (T4): 39.4 kg FENAMIPHOS®

Treatment 5 (T5): untreated control

The results reported for each treatment, summarized in the Tables 1-3 below, one for each test site, were obtained by evaluating the nematode type and amount for each replicate and then averaging the five replicates for each treatment.

TABLE 1
Plant-parasitic Nematode Population (per 250 cc soil) 21 Days after Treatment Application at Test Site 1

| | Meloidogyne | Xiphinema | Xiphinema | Helicotylenchus | Pratylenchus | Criconemoides | Paratylenchus | |
|---|---|---|---|---|---|---|---|---|
| Treatment | incognita | index | americanum | spp. | spp. | simile | spp. | Total |
| T1 | 0.00a | 16.00a | 1.00a | 4.00a | 2.00a | 7.60a | 3.00a | 33.60a |
| T2 | 0.00a | 69.00a | 0.00a | 3.00a | 3.00a | 4.00a | 37.00a | 116.00a |
| T3 | 0.80a | 18.00a | 4.00a | 1.00a | 3.00a | 3.00a | 17.00a | 46.80a |
| T4 | 0.00a | 30.00a | 10.00a | l0.00a | 2.00a | 2.00a | 26.00a | 80.00a |
| T5 | 0.00a | 23.00a | l0.00a | 6.00a | 4.00a | 6.00a | 5.00a | 54.00a |
| LSD (p = 0.05) | 1.55 | 112.8 | 19.4 | 20.47 | 10.79 | 14.68 | 47.99 | 152.1 |

At 21 days after the post-harvest application at Test Site 1, the iodine treatments applied at 22.6 kg (T1) and 45.3 kg (T3) of iodine per treated hectare decreased the overall total plant-parasitic nematode population by 38% and 13%, respectively, compared with the untreated control, as shown in Table 1.

In analyzing several of the more important specific nematode genuses, iodine applied in T1 and T3 resulted in a 30% and 22% decrease, respectively, in the Xiphinema index populations. Iodine applied in T1, T2, and T3 decreased the Xiphinema americanum populations by 90%, 100%, and 60%, respectively, relative to the untreated control. In contrast, FENAMIPHOS® had no effect on the soil Xiphinema americanum nematode population and caused a 30% population increase in the soil Xiphinema index populations relative to the untreated control.

TABLE 2
Plant-parasitic Nematode Population (per 250 cc soil) 21 Days after Treatment Application at Test Site 2

| | Meloidogyne | Kiphinema | Xiphinema | Helicotylenchus | Pratylenchus | Criconemoides | Paratylenchus | |
|---|---|---|---|---|---|---|---|---|
| Treatment | incognita | index | americanum | spp. | spp. | simile | spp. | Total |
| T1 | 20.00a | 19.60a | 4.40a | 1.40a | 50.00a | 0.00a | 0.80a | 96.20a |
| T2 | 102.20a | 30.20a | 2.80a | 1.60a | 21.00a | 14.00a | 2.20a | 174.00a |
| T3 | 10.00a | 10.20a | 0.00a | 3.40a | 47.00a | 0.00a | 1.00a | 71.60a |
| T4 | 19.60a | 49.40a | 9.00a | 0.00a | 9.00a | 6.80a | 0.00a | 94.00a |
| T5 | 125.00a | 13.00a | 0.00a | 0.00a | 37.00a | 2.00a | 1S.00a | 192.00a |
| LSD (p = 0.05) | 270.9 | 65.82 | 18.72 | 5.82 | 132.5 | 31.44 | 27.35 | 277.4 |

The applications of iodine in T1, T2, and T3 at Test Site 2 resulted in respective decreases of 51%, 9%, and 63%, respectively, in the overall total plant-parasitic nematodes populations relative to the untreated control, as shown in Table 2. The FENAMIPHOS® treatment (T4) gave a 51% reduction in the overall total plant-parasitic nematodes populations relative to the untreated control (T5).

Xiphinema index populations, one of the more critical species which is desirable to control, were reduced by 84%, 92%, and 84% with iodine applied in T1 and T3, and in the standard treatment T4, respectively. Xiphinema americanum, another important dagger nematode species, was not controlled with either FENAMIPHOS® or iodine at lower concentrations. However, iodine in T3 decreased the Xiphinema americanum population by 22% relative to T5. In general, iodine, with the exception of the T3 treatment which controlled all the species within the statistical limits, controlled the populations of the Tylenchorhynchus and Paratylenchus nematode species, but slightly increased the Helicotylenchus, Pratylenchus, and Criconemoides simile (Cobb's Ring Nematode) soil nematode populations.

TABLE 3
Plant-parasitic Nematode Population (per 250 cc soil) 21 Days after Treatment Application at Test Site 3

| | Meloidogyne | Kiphinema | Xiphinema | Helicotylenchus | Pratylenchus | Criconemoides | Paratylenchus | Tylenchorhynchus | |
|---|---|---|---|---|---|---|---|---|---|
| Treatment | incognita | index | americanum | spp. | spp. | simile | spp. | spp. | Total |
| T1 | 15.60a | 0.00a | 4.00a | 7.40a | 8.00a | 6.00a | 6.00a | 0.00a | 47.00a |
| T2 | 26.60a | 10.00a | 7.00a | 105.00a | 0.00a | 2.00a | 2.00a | 0.80a | 153.40a |
| T3 | 73.00a | 0.00a | 18.20a | 83.20a | 5.00a | 6.00a | 0.00a | 0.00a | 185.40a |
| T4 | 70.40a | 0.00a | 5.40a | 8.00a | 2.00a | 19.00a | 1.00a | 0.00a | 105.80a |
| T5 | 36 00a | 2.00a | 18.00a | 41.00a | 3.00a | 52.00a | 0.00a | 0.00a | 152.00a |
| LSD | 119.6 | 14.57 | 24.05 | 220.6 | 11.19 | 106.9 | 11.83 | 1.55 | 231.4 |
| (p = 0.05) | | | | | | | | | |

Iodine, applied in T1 at Test Site 3, resulted in a 70% decrease in the overall total plant-parasitic nematode population relative to the untreated control, as shown in Table 3. The T4 application yielded a 30% reduction in the overall total plant-parasitic nematode population with respect to untreated control T5.

Iodine applied in T1, T2, and T3 yielded 80%, 15%, and 9% reductions, respectively, in the dagger nematode (Xiphinema index+Xiphinema americanum) populations relative to T5. The T4 application resulted in a 73% reduction in the dagger nematode populations. Meloidogyne incognita populations were reduced by 57% and 26% with iodine applied in T1 and T2, respectively.

Overall, T1 gave the best results relative to the untreated control T5. The T2 and T3 iodine treatments were not statistically different from T5. T4 decreased the total nematode population by 31% relative to T5. However, when the results are analyzed in a group nematode population control analysis without considering the Helicotylenchus nematode species, all the iodine treatments exhibited a good degree of total control on the remaining group of nematode species: T1 gave a 64% reduction in group nematode population, T2 gave a 56% reduction in group nematode population, T3 gave an 8% reduction in group nematode population, and T4 gave a 12% reduction in group nematode population.

### Example 9

### Treatment of Tomato, Pepper and Strawberry Plots to Prevent Infestation from Soilborne Plant Pathogens

Soil treatments were made to individual 0.1 acre tomato, pepper, and strawberry plots via subterranean drip irrigation just prior to planting the certified disease-free transplants with two different solutions, each containing a different concentration of free iodine. 7800 liters of aqueous potassium iodide solution A or B, containing 0.06 and 0.12 grams of free iodine/liter, respectively, was used to protect the plants from soil borne plant pathogens. The application rate of free iodine was 4,86 kg free iodine/acre for Solution A and 9.36 kg free iodine/acre for Solution B.

The appearance of the plants treated with Solution A appeared little better than the untreated control plots. However, with Solution B, the appearance of plants in the tomato, pepper, and strawberry plots so treated was as good as or better than commercial reference plots in which the soil was conventionally treated with methyl bromide before the plants were planted.

These results show that pest treatment with a composition of the invention, in the form of a solution containing 0.12 free iodine/liter, by the method of the invention was effective in preventing damage to tomato, pepper, and strawberry plants by preventing damage from soil-born pests, and was more effective than conventional soil treatment with methyl bromide before the plants were planted.

### Example 10

### Treatment of Tomato Crops to Prevent Infestation from Soilborne Plant Pathogens

Field trials were made to determine the efficacy of iodine as a viable alternative to methyl bromide for the control and prevention of plant parasitic nematodes and soilborne pathogens in tomato production areas. The certified disease-free tomato transplant variety used in all experiments was “Asgrown 47”. Additionally, the following methods and materials were used.

Test Site Descriptions:

The soil at Test Site 4 was naturally infested by a moderate to low population of tomato plant parasitic nematodes (Belonolaimus, Criconemoides simile, Helicotylenchus, Hoplolaimus, Longidorus, Meloidogyne incognita, Pratylenchus, Xiphinema). There was also a high infestation of soilborne fungal pathogens (Fusarium oxysporum, Phytophthora, Rhizoctonia) and a high infestation of bacterial pathogens (Pseudomonas solanacearum).

The soil at Test Site 5 was naturally infested by moderate populations of plant parasitic nematodes (Meloidogyne incognita, Pratylenchus, Xiphinema, Trichodorus, Criconema, Hoplolaimus, Belonolaimus). There was also a high infestation of soilborne fungal pathogens (Fusarium oxysporum) and viruses (Tomato Spotted Wilt Virus).

Experimental Design:

All experiments were carried out in four replications in a randomized block design. Data from each plot was subjected to analyses of variance and mean separation (ANOVA, alpha 0.05). Treated plots consisted of a 75 ft long row of 50 plants spaced 18″ apart on the bed (Test Site 4 width at bed-top=2.625 ft; Test Site 4 width at bed-top=2 ft). Metham sodium and PEBULATE® were used for broad spectrum weed control in manners well known to those in the art.

Soil Treatments:

T6

Iodine at 27.4 lbs/treated acre (1× rate)+metham sodium (Test Site 4) or PEBULATE® (Test Site 5)

Metham sodium was applied at 37.5 gal/treated acre in 1000 gallons of water broadcast sprayed over the bed-top 10 days before the iodine (1×) pre-planting application at Test Site 4. At Test Site 5, PEBULATE® granules were broadcast over the surface of the soil and disked in one month before planting.

The iodine application methodology, by chemigation, is discussed in the following section.

T7

Iodine at 54.8 lbs/treated acre (2× rate)+metham sodium (Test Site 4) or PEBULATE® (Test Site 5)

Applied as in T6; the iodine application methodology, by chemigation, is discussed in the following section.

T8

Methyl iodide (1× rate)/chloropicrin at 67/33 by weight

Applied at 350 lb/treated acre by shank-injection 10-12″ deep.

T9

Methyl iodide (0.5× rate)

Applied at 116 lb/treated acre by shank-injection 10-12″ deep.

T10

Metham sodium (2× rate)

Applied at 75 gal/treated acre in 1″ irrigation water three weeks before planting with triple drip lines.

T11

Metham sodium (1× rate)

Applied at 37.5 gal/treated acre followed by broadcast soil surface spray/incorporation.

T12

TELONE C35®+BASAMID®

BASAMID® was applied at 200 lb/treated acre one month before planting via broadcast over the bed-top and then watered-injection with a sprinkler.

TELONE C35® was applied at 35 gal/treated acre via shank-injection to a bed which was covered with a tarp immediately after injection.

T13

Methyl bromide/chloropicrin at 67/33 by weight

Applied at 350 lb/treated acre by shank-injection 10-12″ deep.

T14

FOSTHIAZATE 900®+chloropicrin+PEBULATE® (only included at Test Site 5)

Chloropicrin, supplied in the form of an emulsifiable concentrate, was diluted and applied at 200 lb/treated acre 21 days before planting. FOSTHIAZATE 900®, also supplied in the form of an emulsifiable concentrate, was diluted and applied at 4.5 lb active ingredient/treated acre 2-3 days prior to transplanting.

T15

Propargyl bromide

Applied at 150 lb/treated acre in 1.5″ water irrigation 21 days before planting with double drip lines.

T16

Chloropicrin+metham sodium

Metham sodium was applied in accordance with the procedure described above for T3, one week before the chloropicrin pre-planting application. The latter, supplied in the form of an emulsifiable concentrate, was diluted and applied at 300 lb/treated acre 21 days prior to transplanting.

T17

Untreated control

Iodine Application Methodology:

Iodine in Treatment 6 (T6) at 1× rate was applied as follows. Prior to its injection via the irrigation system, the active solution and emulsifier composition components were mixed to form Plant and Crop Protectant Composition 3. The pre-planting application of Plant and Crop Protectant Composition 3 was made via double drip line injection at 27.4 lbs of iodine/treated acre in 1 ″ irrigation water 14 days prior to planting. An additional 1″ of irrigation water was applied 5 days before planting. One after-planting application of Plant and Crop Protectant Composition 3, at 18.1 lbs of iodine/treated acre in 1″ irrigation water per treated bed acre, was applied at 21 days after planting (“DAP”). The after-planting application was immediately followed by irrigation with 0.5″ of water so as to flush the injection/irrigation system.

Iodine in Treatment 7 (T7) at 2× rate was applied as follows. Prior to its injection via the irrigation system, the active solution and emulsifier composition components were mixed to form Plant and Crop Protectant Composition 3. The pre-planting application of Plant and Crop Protectant Composition 3 was made via double drip line injection at 54.8 lbs of iodine/treated acre in 2″ irrigation water 14 days prior to planting. Two after-planting applications of Plant and Crop Protectant Composition 3, each at 18.1 lbs of iodine/treated acre in 1″ irrigation water per treated bed acre, were applied at equally spaced intervals of 21 DAP; the first after-planting application was 21 DAP, the second after-planting application was 42 DAP. Each after-planting application was immediately followed by irrigation with 0.5″ water so as to flush the injection/irrigation system.

Evaluation Methodology:

Treatment effects on nematode population was assessed as follows. Nematode populations were assessed by taking soil samples from plots:

before the application of any soil treatment,

following pre-planting treatment application, if any,

following the first after-planting application, typically 10 DAP,

before the second after-planting application, typically 45 DAP, and

following the second after-planting application.

A 2.5 cm diameter soil probe was used to take 12 soil cores per plot at a depth of 10-15 cm; every sample was maintained moist and cool in transit to the laboratory for the assessment. Nematode populations were quantified using a Baermann funnel and Cobb's decanting and sieving technique, using sieves with 20, 100, 325 and 400 μm-apertures.

Treatment effect on soilborne fungal pathogens was assessed as follows. Soilborne fungal populations were assessed by taking soil samples from plots:

following pre-planting treatment application, if any,

following the first after-planting application, typically 10 DAP,

before the second after-planting application, typically 45 DAP, and

following the second after-planting application.

A 2.5 cm diameter soil probe was used to take 12 soil cores per plot at a depth of 10-15 cm; every sample was maintained moist and cool in transit to the laboratory for the assessment. The soil samples were placed on media selective for each pathogen. Tomato plants were rated for, inter alia, the following fungi: Erwinia carotovora subsp. carotovora (Bacterial stem rot), Fusarium oxysporum f.sp. lycopersici (Wilt), F. oxysporum f.sp. radici-lycopersici (Crown rot), Pseudomonas solanacearum (Bacterial wilt), Rhizoctonia solani (Damping-off), and Sclerotium rolfsii (Southern blight).

Crop Management:

Crops were managed according to tomato industry standard procedures. Irrigation with 7-0-7 fertilizer was done once a week and watering was done twice a week in each trial location. One hour irrigation in the morning and one hour of irrigation at noon was done at Test Site 4; 30 minutes of irrigation in the morning and 45 minutes of irrigation at noon was done at Test Site 5.

The following results were obtained for the tomato plants, discussed first for Test Site 4 as summarized in Tables 4-7, and then for Test Site 5 as summarized in Tables 8-11.

Test Site 4:

Iodine treatments applied at each of the 1× and 2× rates (T6 and T7, respectively) reduced parasitic nematode populations compared to the untreated control (T17) at 10 DAP (see Table 4). Specifically, methyl iodide at 0.5× (T9) and, to a greater extent, iodine at the 2× rate tended to increase populations of the beneficial non-parasitic nematodes when compared to the control. This indicates that these treatments, especially iodine at the 2× rate, are not affecting populations of nematodes that may be beneficial for maintaining natural/beneficial microflora in the soil.

Numerically, iodine treated plots (T6, T7) yielded greater tomato plant height and top weight than the untreated control (T17) but slightly less than methyl bromide (T13) at 21 DAP. There were insignificant differences in root weight among the treatments. Although small differences were observed between the untreated control and the methyl bromide and iodine treatments for populations of Meloidogyne incognita (Root Knot Nematode) at 10 DAP, iodine applied at 1× and 2× rates was comparable to methyl bromide in gall rate, and the roots from these treatments had significantly less galls/root and tended to have less gall/g root than the untreated control.

Both the 1× and 2× rates of iodine (T6, T7) controlled plant parasitic nematodes as well as methyl bromide (T13) and significantly better than the untreated control (T17) at 45 DAP (see Table 6). There were insignificant differences in nonparasitic nematode populations among soil treatments at 45 DAP. However, iodine at the 2× rate still tended to allow for higher populations of nonparasitic nematodes, which further indicates this product's ability to maintain and/or increase populations of possible beneficial nematodes in the soil profile.

There were no statistically significant differences in Fusarium, Phytophthora or Rhizoctonia among treatments at 45 DAP (see Table 7). Although the values may not be statistically significant, the iodine treatments led to numerically lower levels of Phytophthora in the soil at 45 DAP.

TABLE 4
Parasitic and Nonparasitic Nematodes Assay at 10 DAP in Tomato
Plants at Test Site 4

| | Nematodes/250 cc soil | |
|---|---|---|
| | Plant parasitic | Nonparasitic |
| Treatment | nematodes¹ | nematodes² |
| Iodine 1X + Metham Sodium | 14ab | 1,343a |
| Iodine 2X + Metham Sodium | 32ab | 1,828a |
| Methyl Iodide 1X + Chloropicrin | 41ab | 1,272a |
| Methyl Iodide 0.5X | 23ab | 1,508a |
| Metham Sodium 2X | 5b | 889a |
| Metham Sodium 1X | 27ab | 944a |
| TELONE C35 ® + BASAMID ® | 5b | 722a |
| Methyl Bromide/Chloropicrin 67/33 | 18ab | 982a |
| FOSTHIAZATE 900 ® + Chloropicrin | 32ab | 1,434a |
| Propargyl Bromide | 9ab | 1,304a |
| Chloropicrin + Metham Sodium | 37ab | 1,842a |
| Untreated Control | 122a | 1,378a |
| LSD (p = 0.05) | 114.26 | 1,321.5 |

¹Plant parasitic nematodes: Belonolaimus, Criconemoides simile, Helicotylenchus, Hoplolaimus, Longidorus, Meloidogyne incognita, Pratylenchus, and Xiphinema.
²Soil samples taken following pre-planting treatment application and before first after-planting application.

TABLE 5
Soilborne Fungal Assay at 10 DAP in Tomato Plants at Test Site 4

| | Fusarium oxysporum¹ |
|---|---|
| Treatment | Log (cfu/g soil) |
| Iodine 1X + Metham Sodium | 3.51a |
| Iodine 2X + Metham Sodium | 3.68a |
| Methyl Iodide 1X + Chloropicrin | 2.19bcd |
| Methyl Iodide 0.5X | 3.79a |
| Metham Sodium 2X | 1.78cd |
| Metham Sodium 1X | 2.86abd |
| TELONE C35 ® + BASAMID ® | 3.36ab |
| Methyl Bromide/Chloropicrin 67/33 | 3.47a |
| FOSTHIAZATE 900 ® + Chloropicrin | 2.78abc |
| Propargyl Bromide | 1.26d |
| Chloropicrin + Metham Sodium | 1.99cd |
| Untreated Control | 3.40ab |
| LSD (p = 0.05) | 1.22 |

¹Soil samples taken following pre-planting treatment application and before first after-planting application; cfu = colony forming units.

TABLE 6
Parasitic and Nonparasitic Nematodes Assay at 45 DAP
in Tomato Plants at Test Site 4

| | Nematodes/250 cc soil | |
|---|---|---|
| | Plant parasitic | Nonparasitic |
| Treatment | nematodes¹ | nematodes² |
| Iodine 1X + Metham Sodium | 18.5b | 1,035.5a |
| Iodine 2X + Metham Sodium | 27.5b | 2,234.5a |
| Methyl Bromide/Chloropicrin 67/33 | 0.0b | 1,056.8a |
| Untreated Control | 123.8a | 1,329.0a |
| LSD (p = 0.05) | 95.11 | 1,673.3 |

¹Plant parasitic nematodes: Criconemoides simile, Meloidogyne incognita, Pratylenchus, and Xiphinema.
²Soil samples taken following first after-planting treatment application and before second after-planting application.

TABLE 7
Soilborne Fungal Pathogens Assay at 45 DAP in Tomato Plants
at Test Site 4

| | Fusarium | | |
|---|---|---|---|
| Treatment | oxysporum¹ | Phytophthora¹ | Rhizoctonia¹ |
| Iodine 1X + Metham | 3.37a | 1.90a | 3.03a |
| Sodium | | | |
| Iodine 2X + Metham | 3.25a | 0.00a | 2.37a |
| Sodium | | | |
| Methyl Bromide/ | 2.72a | 0.61a | 2.88a |
| Chloropicrin 67/33 | | | |
| Untreated Control | 3.63a | 2.97a | 2.83a |
| LSD (p = 0.05) | 1.31 | 3.61 | 0.76 |

¹Soil samples taken following first after-planting treatment application and before second after-planting application; Log (cfu/g soil) where cfu = colony forming units.

Test Site 5:

Both iodine treatments (T6, T7) and the methyl bromide treatment (T13) reduced parasitic nematodes compared to the untreated control (T17) at this test site (see Table 8). Advantageously, both iodine treatments significantly increased the beneficial nonparasitic nematode populations after the pre-planting application at both rates.

At 21 DAP there were no differences among soil treatments in gall ratings. The untreated control (T17) was not different from methyl bromide (T13) with respect to galling. The iodine treatments (T6, T7) had similar levels of Fusarium oxysporum as the methyl iodide treatments (T8, T9) and the untreated control (see Table 9). All of these treatments had significantly more Fusarium oxysporum levels in soil than methyl bromide at 26 DAP.

At 45 DAP, the iodine treatments (T6, T7) had numerically better control of plant parasite nematodes than the untreated control (T17) and were statistically the same as the methyl bromide treatment (T13) (see Table 10). The iodine treatments at either the 1× or 2× rate allowed for significantly more non-parasitic nematodes to remain in the soil than methyl bromide, indicating their ability to maintain the beneficial natural microflora.

Iodine at the 2× rate demonstrated better control of plant parasitic nematodes at 63 DAP when compared to the untreated control (see Table 11). There were insignificant differences between these treatments in the non-parasitic nematode populations present.

TABLE 8
Parasitic and Nonparasitic Nematodes Assay at 10 DAP in Tomato
Plants at Test Site 5

| | Nematodes/250 cc soil | |
|---|---|---|
| | Plant parasitic | Nonparasitic |
| Treatment | nematodes¹ | nematodes² |
| Iodine 1X + PEBULATE ® | 182ab | 3,282abc |
| Iodine 2X + PEBULATE ® | 117abc | 4,192ab |
| Methyl Iodide 1X + Chloropicrin | 5c | 1,233cd |
| Methyl Iodide 0.5X | 0c | 1,229cd |
| Metham Sodium 2X | 0c | 1,451cd |
| Metham Sodium 1X | 7c | 651d |
| TELONE C35 ® + BASAMID ® | 0c | 743d |
| Methyl Bromide/Chloropicrin 67/33 | 14bc | 1,240cd |
| FOSTHIAZATE 900 ® + Chloropicrin + | 42bc | 1,985cd |
| PEBULATE ® | | |
| Propargyl Bromide | 0c | 1,600cd |
| Chloropicrin + Metham Sodium | 7c | 2,244bcd |
| Untreated Control | 287a | 4,730a |
| LSD (p = 0.05) | 171.21 | 2,173.5 |

¹Plant parasitic nematodes: Meloidogyne incognita, Pratylenchus, and Xiphinema.
²Soil samples taken following pre-planting treatment application and before first after-planting application.

TABLE 9
Soilborne Fungal Assay at 26 DAP in Tomato Plants at Test Site 5

| | Fusarium oxysporum¹ |
|---|---|
| Treatment | Log (cfu/g soil) |
| Iodine 1X + PEBULATE ® | 3.47a |
| Iodine 2X + PEBULATE ® | 3.38a |
| Methyl Iodide 1X + Chloropicrin | 3.32ab |
| Methyl Iodide 0.5X | 3.44a |
| Metham Sodium 2X | 0.00e |
| Metham Sodium 1X | 0.54de |
| TELONE C35 ® + BASAMID ® | 0.57de |
| Methyl Bromide/Chloropicrin 67/33 | 1.40c |
| FOSTHIAZATE 900 ® + Chloropicrin + | 1.73c |
| PEBULATE ® | |
| Propargyl Bromide | 1.10cd |
| Chloropicrin + Metham Sodium | 2.61b |
| Untreated Control | 3.41a |
| LSD (p = 0.05) | 0.76 |

¹Soil samples taken following first after-planting treatment application; cfu = colony forming units.

TABLE 10
Parasitic and Nonparasitic Nematodes Assay at 45 DAP in Tomato
Plants at Test Site 5

| | Nematodes/250 cc soil | |
|---|---|---|
| | Plant parasitic | Nonparasitic |
| Treatment | nematodes¹ | nematodes² |
| Iodine 1X + PEBULATE ® | 55.0ab | 2,631.0ab |
| Iodine 2X + PEBULATE ® | 68.8ab | 2,809.8a |
| Methyl Bromide/Chloropicrin 67/33 | 9.3b | 1,058.8b |
| Untreated Control | 256.8a | 2,757.0a |
| LSD (p = 0.05) | 230.11 | 1,651.4 |

¹Plant parasitic nematodes: Belonolaimus, Criconema, Hoplolaimus, Meloidogyne incognita, Pratylenchus, and Xiphinema.
²Soil samples taken following first after-planting treatment application and before second after-planting application.

TABLE 11
Parasitic and Nonparasitic Nematodes Assay at 63 DAP in Tomato
Plants at Test Site 5

Nematodes/250 cc soil

| | Plant parasitic | Nonparasitic |
|---|---|---|
| Treatment | nematodes¹ | nematodes² |
| Iodine 2X + Pebulate ® | 155.8b | 1,526.0a |
| Untreated Control | 742.5a | 1,934.0a |
| LSD (p = 0.05) | 467.41 | 494.37 |

¹Plant parasitic nematodes: Meloidogyne incognita, Pratylenchus, Trichodorus, and Xiphinema.
²Soil samples taken following after-planting treatment application.

### Example 11

### Fungicide In Vitro Test on Berries

Berry rot diseases of small berries, e.g., grapes, blueberries and strawberries, often cause substantial yield reductions. Important fruit diseases of grapes include bitter rot (Greeneria uvicola), ripe rot (Colletotrichum sp.), and Macrophoma rot (Botryosphaeria dothidea). The bitter rot fungus also causes an important and detrimental leaf spot. Regular preventative fungicide applications during the growing season will reduce both fruit and foliar diseases.

The major diseases of rabbiteye and southern highbush blueberries, the two species of blueberries grown commercially in the southeastern U.S., include stem blight (Botryosphaeria dothidea), Phytophthora root rot (Phytophthora cinnamomi), and various fruit rots (Alternaria, Colletotrichum sp., Phomopsis). Only a few fungicides are registered for control of blueberry diseases, therefore, there is an unmet need in the industry for other effective chemicals to manage these diseases and to prevent the development of fungicide tolerance among the pathogens.

Studies were carried out to determine the efficacy of active iodine (AI) as a preventative and/or curative treatment for fruit and foliar diseases. In vitro trials were conducted to determine if the AI inhibits the growth of several small fruit fungal pathogens in cultures. The pathogens tested were species of Alternaria, Botryosphaeria, Colletotrichum, Fusarium, Greeneria, and Phytophthora isolated from small fruit hosts. The following materials and methods were used in these trials. Potato dextrose agar (PDA) medium (BACTO®) was prepared in 80% final volume, i.e., 39 grams of PDA in 800 ml of water instead of in the normal 1000 ml of water. After autoclaving, the molten PDA was dispensed into 90 mm glass petri plates (about 19 ml/plate). After the PDA had solidified, 1 ml of each of three different aqueous iodine stock solutions was added to each plate and evenly distributed over the plate surface such that a final concentration of 300, 30 or 3 ppm AI was achieved. For the control treatment (0 ppm AI), 1 ml of sterile water was added to the surface of the PDA plate. The final volume of PDA plus added treatment in each plate was 20 ml.

The plates were allowed to air dry in the dark in a laminar flow hood until no liquid was visible on the agar surface, typically several hours to overnight. Each plate was inoculated by inverting onto the agar surface a 4 mm plug cut from a 7 to 14 day old culture of each fungal isolate. The fungi were allowed to grow for 5 days in the dark at room temperature (about 25° C.). Thereafter, fungal colony size was determined by measuring the diameter of each colony. Each study was replicated in triplicate and the three replicates for each were averaged; the results are shown in Table 12.

TABLE 12
Fungal Colony Diameter (mm) after 5 Days Growth at 20° C. on
Potato Dextrose Agar Medium Flooded with Active (Iodine)
at Three Concentrations

| | | | | | | LSD |
|---|---|---|---|---|---|---|
| | | 0 | 3 | 30 | 300 | (p = |
| Fungus | Host: Isolate | ppm | ppm | ppm | ppm | 0.05) |
| Colletotrichum | Strawberry: | 60.0 | 29.3 | 18.3 | 5.3 | 2.3 |
| gloeosporioides | Ark P-1 | | | | | |
| | Strawberry: | 53.3 | 30.3 | 15.7 | 6.3 | 3.9 |
| | CG 162 | | | | | |
| Colletotrichum | Strawberry: CA-1 | 35.7 | 25.0 | 14.3 | 5.0 | 1.2 |
| acutatum | Strawberry: Goff | 34.7 | 22.3 | 13.3 | 5.0 | 2.3 |
| Colletotrichum | Strawberry: | 53.0 | 26.3 | 18.0 | 8.3 | 3.1 |
| fragariae | CF-63 | | | | | |
| | Strawberry: | 59.7 | 32.7 | 17.0 | 5.0 | 2.4 |
| | CF-75 | | | | | |
| Alternaria sp. | Blueberry: | 36.0 | 20.7 | 20.7 | 5.0 | 1.5 |
| | Fruit | | | | | |
| Phytophthora sp. | Blueberry: Soil | 40.3 | 21.0 | 12.3 | 5.0 | 4.4 |
| Fusarium sp. | Strawberry: Soil | 38.0 | 32.7 | 25.0 | 8.7 | 3.4 |
| Greeneria | Grape: Bitter Rot | 25.0 | 10.3 | 7.3 | 5.0 | 2.0 |
| uvicola | | | | | | |
| (Melanconium) | | | | | | |
| Boptryosphaeria | Blueberry: Stem | 84.3 | 36.0 | 14.0 | 6.0 | 9.3 |
| dothidea | Blight | | | | | |
| | Grape: | 55.7 | 23.3 | 13.7 | 5.0 | 15.4 |
| | Macrophoma | | | | | |

These results demonstrate that there was a significant reduction in the colony size of all fungal isolates after 5 days growth on the AI amended agar compared to the growth on unamended agar (Table 12). There was also a significant reduction in colony size as the amount of AI increased, i.e., increasing the concentration of AI decreased the colony size for the host: isolate combinations tested.

### Example 12

### Protection of Commercial Pond-Raised Shrimp from Vibrio spp.

Elemental iodine was dissolved in an equimolar amount to the iodine in an aqueous potassium iodide stock solution. The stock solution contained 57% by weight potassium iodide. The resulting solution was applied to commercial shrimping ponds at two treatment levels in order suppress the level of Vibrio spp. bacteria, which is pathogenic to shrimp and causes “white spot” disease. A quaternary ammonium compound (QA), used in the industry as the standard preventative treatment for white spot disease, was used as the treated control. All treatments were compared to shrimp from untreated ponds. The follow treatment levels were used, each per hectare of shrimp pond:

Treatment 18 (T18): 15 g iodine

Treatment 19 (T19): 30 g iodine

Treatment 20 (T20): 100 g QA

Treatment 21 (T21): untreated control

The methodology for the treatments was as follows. The Vibrio spp. level was determined in each commercial shrimping pond used. Then, each treatment was diluted in 200 L of water and sprayed onto the surface of a 1 hectare pond. Three replicates were done per treatment. Thereafter, samples were taken for analysis every 24 hours for three days. The results reported were obtained by comparing these Vibrio spp. levels to the pre-treatment level and then averaging the three replicates for each treatment. Table 13 summarizes the results obtained for each treatment.

TABLE 13
Decrease in Vibrio spp. Population in Commercial Shrimping Ponds
at Three Times After Treatment

| Decrease in | | | | |
|---|---|---|---|---|
| Vibrio spp. | | | | |
| Population | Treatment | Treatment | Treatment | Treatment |
| after | 18 | 19 | 20 | 21 |
| 24 hours | −78.1% | −93.5% | −49.2% | −5.2% |
| 48 hours | −75.0% | −62.0% | −76.6% | +41.0% |
| 72 hours | −46.0% | −33.0% | −51.0% | +81.0% |

It is evident from these results that both iodine treatments (T18, T19) performed better than QA (T20) after 24 hours and about as least as well as the QA thereafter, even though the iodine was applied at rates only a fraction of the QA application rate. Additionally, both iodine treatments performed far better than the untreated control (T21).

Applications were made twice more during the growing-out period and no white spot disease was observed in the shrimp harvested from treatment 19. The control ponds yielded less than half of the weight in salable shrimp than the iodine-treated ponds because of heavy losses from white spot disease.

While the present invention has been described with reference to preferred embodiments and illustrative examples, it should be understood that one of ordinary skill in the art, after reading the foregoing specification, would be able to effect various changes, substitutions of equivalents and modifications to the methods and compositions described herein. Therefore, it is intended that the scope of the invention not be limited by reference to the illustrative examples. Rather, the scope of the present invention should be construed with reference to the accompanying claims.

What is claimed is:

1. A method for protecting an agricultural substance from pests which are harmful or pathogenic to the agricultural substance, the method comprising: selecting a protectant composition which comprises molecular iodine or which, upon application, releases molecular iodine from the group consisting of molecular iodine, an ionic iodine complex comprising iodine and an ionic complexing agent, and mixtures thereof, and applying the protectant composition to the agricultural substance, which is optionally genetically modified, as many times as necessary per annum in an amount effective to prevent substantial damage to the agricultural substance from the pests thereby protecting the agricultural substance.

2. The method of claim 1, further comprising selecting the agricultural substance from the group consisting of crops, harvested crops, turf grasses, sod, seedlings, transplants, shrimp, and mixtures thereof.

3. The method of claim 1, further comprising selecting at least one pest from the group consisting of fungi, nematodes, viruses, bacteria and weeds.

4. The method of claim 1, further comprising adding at least one additive to the composition, the additive selected from the group consisting of secondary active ingredients and inert ingredients, with the proviso that the additive is not a crystalline organic tricarboxylic acid.

5. The method of claim 1, further comprising selecting the protectant composition from the group consisting of molecular iodine, an inorganic ionic iodine complex comprising iodine and an inorganic ionic complexing agent, and mixtures thereof and, when the agricultural substance is a plant, choosing the plant from the group consisting of grain-bearing plants, nut-bearing plants, banana plants, pineapple plants, melon plants, strawberry plants, blackberry plants, blueberry plants, peach trees, nectarine trees, pear trees, apple trees, grape vines, vegetable plants, pine trees, olive trees, oil palm trees, rubber trees, coffee plants, cotton plants, ornamental plants, flowers, flowering-bulb-producing plants, tobacco plants, medicinal herbs, and seasoning herbs.

6. The method of claim 1, further comprising applying the composition by at least one method selected from the group consisting of spraying, overhead irrigation, plant bed irrigation, chemigation, subterranean irrigation, pressure injection, shank injection, incorporation, rototilling and broadcasting.

7. The method of claim 6, further comprising incorporating the composition directly into a soil, wherein the composition is present in the form of a melted liquid, a heated gas, or as solid particles and wherein the application is made before planting or transplanting.

8. The method of claim 6, further comprising applying the composition directly to a soil with an irrigation system comprising a cartridge, optionally in-line, containing a filler comprising the composition.

9. The method of claim 8, wherein the application is made before or after planting or transplanting.

10. The method of claim 6, further comprising applying the composition to a soil or a plant foliage by coating the composition onto a substantially inert solid to form a coated solid, broadcasting the coated solid onto the soil or foliage and, optionally, incorporating the coated solid into the soil.

11. The method of claim 10, wherein the application is made before or after planting or transplanting.

12. A method for protecting an agricultural substance from pests which are harmful or pathogenic to the agricultural substance or for curing a pest-damaged agricultural substance, the method comprising: selecting a composition which comprises molecular iodine or which, upon application, releases molecular iodine from the group consisting of molecular iodine, an ionic iodine complex comprising iodine and an ionic complexing agent, and mixtures thereof; and applying a sufficient amount of the composition to the agricultural substance, which is optionally genetically modified, directly or indirectly as many times as necessary per annum so as to result in the application of from at least about 2.53 grams to about 80,000 grams of molecular iodine per acre of agricultural substance and so as to prevent substantial damage to the agricultural substance from the pests or to substantially reduce preexisting damage to the agricultural substance caused by the pests.

13. The method of claim 12, further comprising selecting at least one pest from the group consisting of fungi, nematodes, viruses, bacteria and weeds.

14. The method of claim 12, further comprising applying a sufficient amount of the composition to the agricultural substance so as to result in the application of from at least about 5,000 grams to about 25,000 grams of molecular iodine per acre of agricultural substance.

15. The method of claim 12, further comprising covering at least one portion of the plants selected from the group consisting of fruits, vegetables and flowers before applying the composition to prevent contact between the covered portion and the molecular iodine or ionic iodine complex.

16. The method of claim 12, further comprising choosing the plant from the group consisting of grain-bearing plants, nut-bearing plants, banana plants, pineapple plants, melon plants, strawberry plants, blackberry plants, blueberry plants, peach trees, nectarine trees, pear trees, apple trees, grape vines, vegetable plants, pine trees, olive trees, oil palm trees, rubber trees, coffee plants, cotton plants, ornamental plants, flowers, flowering-bulb-producing plants, tobacco plants, medicinal herbs, and seasoning herbs.

17. The method of claim 12, further comprising choosing the plant from the group consisting of wheat, pecan, peanut, strawberry, blackberry, blueberry, grape, banana, peach, nectarine, apple, tomato and coffee plants, flowers and pine trees.

18. The method of claim 12, further comprising selecting plants as the agricultural substance, at least a portion of the plants being surrounded by soil and optionally irrigated; and selecting at least one foliar pest from the group consisting of fungi, viruses and bacteria.

19. The method of claim 18, further comprising applying the composition in a preventative application to at least one of the foliage of the plants, surrounding soil or irrigation water so as to prevent substantial damage to the plants from the foliar pest.

20. The method of claim 12, further comprising selecting plants as the agricultural substance, at least a portion of the plants being surrounded by soil and optionally irrigated; and selecting at least one soilborne pest from the group consisting of fungi, bacteria and weeds.

21. The method of claim 20, further comprising applying the composition in a preventative application to at least one of the foliage of the plants, surrounding soil or irrigation water so as to prevent substantial damage to the plants from the soilborne pest.

22. The method of claim 12, further comprising selecting plants as the agricultural substance, at least a portion of the plants being surrounded by soil and optionally irrigated; and selecting at least one soilborne pest from the group consisting of fungi, nematodes and weeds.

23. The method of claim 22, further comprising applying the composition in a preventative application to at least one of the plants, surrounding soil or irrigation water so as to prevent substantial damage to the plants from the soilborne pest.

24. The method of claim 13, further comprising selecting the agricultural substance from the group of plants, optionally comprising crops, consisting of annual plants, biennial plants and perennial plants, at least a portion of the plants being surrounded by soil and optionally irrigated.

25. The method of claim 24, further comprising applying the composition in a preventative application to at least one of the plants, crops, surrounding soil or irrigation water so as to prevent substantial damage to the plants or crops from the pest.

26. The method of claim 24, further comprising selecting the annual plant from the group consisting of vegetable crops and tobacco.

27. The method of claim 24, further comprising selecting the biennial plant from the group consisting of lilies, foxglove, beets, turnips, parsnip, carrots, artichoke, parsley, cabbage, radish and onion.

28. The method of claim 24, further comprising selecting the perennial plant from the group consisting of trees and bushes.

29. The method of claim 13, further comprising selecting turf grass as the agricultural substance, at least a portion of the grass being surrounded by soil and optionally irrigated.

30. The method of claim 29, further comprising applying the composition in a preventative application to at least one of the grass, surrounding soil or irrigation water so as to prevent substantial damage to the grass from the pest.

31. The method of claim 13, further comprising selecting the agricultural substance from the group of plants, optionally comprising crops, consisting of grape vines, banana plants, stone fruit trees, pome fruit trees, tomato plants, pepper plants, corn plants, rice plants, strawberry plants, tobacco plants, cut-flower-bearing plants, at least a portion of the plants being surrounded by soil and optionally irrigated.

32. The method of claim 31, further comprising applying the composition in a preventative application to at least one of the plants, crops, surrounding soil or irrigation water so as to prevent substantial damage to the plants or crops from the pest.

33. A method for protecting an agricultural substance from pests which are harmful or pathogenic to the agricultural substance or for curing a pest-damaged agricultural substance, the method comprising: selecting a composition which comprises molecular iodine or which, upon application, releases molecular iodine from the group consisting of molecular iodine, an ionic iodine complex comprising iodine and an ionic complexing agent, and mixtures thereof; and applying a sufficient amount of the composition to the agricultural substance, which is optionally genetically modified, directly or indirectly as many times as necessary per annum so as to result in the application of from at least about 1.0 gram to about 50,000 grams of molecular iodine per acre-feet of habitat and so as to prevent substantial damage to the agricultural substance from the pests or to substantially reduce preexisting damage to the agricultural substance caused by the pests, wherein the agricultural substance is selected from the group consisting of commercially raised tilapia, crawfish, crabs, squid, rotifers and shrimp.

34. The method of claim 33, further comprising selecting at least one pest from the group consisting of fungi, viruses and bacteria.

35. The method of claim 33, further comprising selecting shrimp as the agricultural substance and applying the composition to a pond or pool containing the shrimp.

36. A method for protecting an agricultural substance from pests which are harmful or pathogenic to the agricultural substance, the method comprising: selecting at least one agricultural substance from the group consisting of harvested crops and raw agricultural commodities; selecting a protectant composition which comprises molecular iodine or which, upon application, releases molecular iodine from the group consisting of molecular iodine, an ionic iodine complex comprising iodine and an ionic complexing agent, and mixtures thereof; and applying a sufficient amount of the protectant composition to the harvested crops as many times as necessary per annum so as to result in the application of from at least about 0.01 grams to about 5,000 grams of molecular iodine per metric ton of harvested crops and so as to prevent substantial damage to the plants from the pests or to substantially reduce preexisting damage to the agricultural substance caused by the pests.

37. The method of claim 36, further comprising selecting at least one pest from the group consisting of fungi, bacteria and weeds.

38. The method of claim 36, further comprising choosing the harvested crop from the group consisting of wheat, pecans, peanuts, strawberries, blackberries, blueberries, grapes, bananas, peaches, nectarines, apples, tomatoes, coffee beans, flowers and softwood products.

39. The method of claim 36, further comprising applying a sufficient amount of the composition to the harvested crops so as to result in the application of from at least about 0.1 grams to about 500 grams of molecular iodine per metric ton of harvested crops.

40. The method of claim 39, further comprising applying a sufficient amount of the composition to the harvested crops so as to result in the application of from at least about 1 gram to about 50 grams of molecular iodine per metric ton of harvested crops.

41. The method of claim 36, further comprising applying the composition in a preventative application to at least one harvested crop so as to prevent substantial damage to the harvested crop.

42. The method of claim 41, further comprising choosing the harvested crop from the group consisting of seeds and tubers; and selecting at least one pest from the group consisting of fungi, nematodes, viruses, bacteria and weeds.

43. The method of claim 42, further comprising applying the protectant composition, which is present in the form of a concentrated slurry, a powder or as a coating on a substantially inert solid, to seeds with an applying means to treat the seeds without introducing sufficient moisture to cause the seeds to germinate.

44. The method of claim 43, further comprising choosing the applying means from the group consisting of a sprayer, a tank-type sprayer, a squeeze applicator, a drillbox, a planter/seed box, a powder duster, a hand-held duster, a paint brush, a tumbler vessel, a rotating vessel, a shaft agitated vessel and a centrifuged vessel.

45. A method for protecting an agricultural substance selected from the group consisting of plants, crops, harvested crops and mixtures thereof, from pests which are harmful, pathogenic or parasitic to the agricultural substance comprising: selecting a protectant composition which comprises molecular iodine or which, upon application, releases molecular iodine from the group consisting of molecular iodine, an ionic iodine complex comprising iodine and an ionic complexing agent, and mixtures thereof and at least one additive selected from the group consisting of secondary active ingredients and inert ingredients, with the proviso that the additive is not a crystalline organic tricarboxylic acid; and applying the protectant composition to the agricultural substance as many times as necessary per annum in an amount effective to prevent substantial damage to the agricultural substance from the pests or to substantially reduce preexisting damage to the agricultural substance caused by the pests.

46. The method of claim 45, further comprising selecting at least one pest from the group consisting of fungi, nematodes, viruses, bacteria and weeds.

47. The method of claim 45, further comprising selecting the secondary active ingredient from the group consisting of herbicides, fungicides, nematicides, insecticides, bactericides, virucides, and fumigants.

48. The method of claim 45, further comprising selecting the protectant composition from the group consisting of molecular iodine, an inorganic ionic iodine complex comprising iodine and an inorganic ionic complexing agent, and mixtures thereof and, when the agricultural substance is a plant, choosing the plant from the group consisting of grain-bearing plants, nut-bearing plants, banana plants, strawberry plants, blackberry plants, blueberry plants, peach trees, nectarine trees, pear trees, apple trees, grape vines, vegetable plants, pine trees, olive trees, oil palm trees, rubber trees, coffee plants, cotton plants, ornamental plants, flowers, and flowering, bulb producing plants.

49. The method of claim 45, further comprising selecting at least one inert ingredient from the group consisting of carriers, fertilizers, fertilizer components, nutrients, micronutrients, promoters, polyaspartates, biomass, surfactants, emulsifiers, oils, odorants, waxes, salts, preservatives, iodides, rainfastness agents, adhesive extender agents, and tackifying extender agents.

50. The method of claim 49, further comprising selecting the inert ingredient from the group consisting of methyl paraben, propyl paraben, nitrogen, phosphorus, potassium, calcium, magnesium, sulfur, boron, chlorine, copper, iron, manganese, molybdenum, zinc, urea, nitrates, phytosterols, mineral oil, solvents, chelaters, nonylphenol, alkyl polyglycoside oligomers, alkyl polyglucosides, emulsifiers, anionic surfactants, cationic surfactants, amphoteric surfactants, nonionic surfactants, and mixtures thereof.

51. The method of claim 45, further comprising selecting the inert ingredient to be a liquid carrier or a solid carrier.

52. The method of claim 51, further comprising selecting the liquid carrier from the group consisting of water, alcohols, oils used in the formulation of agricultural spray emulsions, solvents used in the formulation of agricultural spray emulsions, and mixtures thereof.

53. The method of claim 45, further comprising selecting the inert ingredient to be a gaseous carrier.

54. The method of claim 53, further comprising selecting the gaseous carrier from the group consisting of air, nitrogen, the inert gases and mixtures thereof.

55. A protectant composition for agricultural substances which comprises molecular iodine or which, upon application, releases molecular iodine wherein the protectant composition is selected from the group consisting of molecular iodine, an ionic iodine complex comprising iodine and an ionic complexing agent, and mixtures thereof, and a gaseous carrier.

56. The protectant composition of claim 55, wherein the gaseous carrier is selected from the group consisting of air, nitrogen, the inert gases and mixtures thereof.

57. The protectant composition of claim 55, which further comprises at least one additive selected from the group consisting of secondary active ingredients and inert ingredients, with the proviso that the additive is not a crystalline organic tricarboxylic acid.

58. The protectant composition of claim 57, wherein the additive further comprises at least one secondary active ingredient selected from the group consisting of herbicides, fungicides, nematicides, insecticides, bactericides, virucides, and fumigants.

59. The protectant composition of claim 57, wherein the additive further comprises at least one inert ingredient selected from the group consisting of carriers, phytosterols, fertilizers, fertilizer components, nutrients, micronutrients, promoters, polyaspartates, biomass, surfactants, emulsifiers, oils, adhesive extender agents, tackifying extender agents, odorants, waxes, salts, preservatives, iodides, and rainfastness agents.

60. The protectant composition of claim 59, wherein the inert ingredient is selected from the group consisting of methyl paraben, propyl paraben, nitrogen, phosphorus, potassium, calcium, magnesium, sulfur, boron, chlorine, copper, iron, manganese, molybdenum, zinc, urea, nitrates, phytosterols, mineral oil, solvents, chelaters, nonylphenol, alkyl polyglycoside oligomers, alkyl polyglucosides, emulsifiers, anionic surfactants, cationic surfactants, amphoteric surfactants, nonionic surfactants, and mixtures thereof.

61. A method for protecting an agricultural substance from pests which are harmful to the agricultural substance, the method comprising: selecting a protectant composition which comprises molecular iodine or which, upon application, releases molecular iodine from the group consisting of molecular iodine, an ionic iodine complex comprising iodine and an ionic complexing agent, and mixtures thereof; applying the protectant composition to a soil; allowing the protectant composition to penetrate into the soil; and contacting the agricultural substance with the protectant composition; wherein the protectant composition is applied to the agricultural substance as many times as necessary per annum in an amount effective to prevent substantial damage to the agricultural substance from the pests or to substantially reduce preexisting damage to the agricultural substance caused by the pests.

62. The method of claim 61, further comprising applying the composition to the soil before contacting the agricultural substance with the composition.

62. The method of claim 61, further comprising applying the composition with an inorganic acid or acetic acid.

64. The method of claim 61, wherein the agricultural substance comprises a substance selected from the group consisting of plant roots of a plant, seeds, tubers, bulbs and shrimp.

65. The method of claim 64, further comprising choosing the plant from the group consisting of grain-bearing plants, nut-bearing plants, banana plants, strawberry plants, blackberry plants, blueberry plants, peach trees, nectarine trees, pear trees, apple trees, grape vines, vegetable plants, pine trees, olive trees, oil palm trees, rubber trees, coffee plants, cotton plants, ornamental plants, flowers, and flowering, bulb producing plants.

66. A protectant composition for agricultural substances which comprises molecular iodine or which, upon application, releases molecular iodine, wherein the protectant composition is selected from the group consisting of molecular iodine, an ionic iodine complex comprising iodine and an ionic complexing agent, and mixtures thereof.

67. The protectant composition of claim 66, wherein the protectant composition consists essentially of at least one ionic iodine complex comprising iodine and an ionic complexing agent wherein the ionic complexing agent is independently selected from the group consisting of M⁺I⁻, [R-L]⁺I⁻, and mixtures thereof, wherein M is a cation, R is or comprises an amine, a sulphide or a sulfoxide, and L is hydrogen or a linear, branched or cyclic alkyl cation comprising from about 1 to about 10 carbon atoms formed by removing an iodine anion from an alkyl iodide.

68. The protectant composition of claim 67, wherein M is selected from the group consisting of Li⁺, Na⁺, K⁺, NH₄⁺, H⁺, ½ Ca²⁺, ½ Fe²⁺ and mixtures thereof, R is selected from the group consisting of methyl amine, ethanolamine, ethylenediamine, choline, hexamethylenediamine, aniline, dimethyl amine, diethanolamine, cyclopentyl amine, triethyl amine, triethanolamine, pyridine, poly-4-vinylpyridine, piperidine, piperazine, dimethyl sulphide, dimethyl sulfoxide and mixtures thereof, and L is hydrogen.

69. The protectant composition of claim 66, which further comprises a liquid carrier or a solid carrier.

70. The protectant composition of claim 69, wherein the liquid carrier is selected from the group consisting of water, alcohols, oils used in the formulation of agricultural spray emulsions, non-phytotoxic and biodegradable solvents, and mixtures thereof.
